(19) United States
(12) Patent Application Publication
(10) Pub. No.: US 2026/0254503 A1
(43) Pub. Date: Aug. 27, 2026

(54) METHOD AND DEVICE FOR RECEIVING AND TRANSMITTING INFORMATION

(71) Applicant: Samsung Electronics Co., Ltd., Suwon-si, Gyeonggi-do (KR)

(72) Inventors: Zhe CHEN, Beijing (CN); Jingxing FU, Beijing (CN); Sa ZHANG, Beijing (CN); Feifei SUN, Beijing (CN)

(21) Appl. No.: 19/489,715

(22) PCT Filed: Jul. 18, 2024
(86) PCT No.: PCT/KR2024/095927

§ 371 Date: Dec. 3, 2025

(30) Foreign Application Priority Data
Jul. 21, 2023 (CN) 202310906682.1
Oct. 25, 2023 (CN) 202311396066.2
Dec. 27, 2023 (CN) 202311824796.8
Jan. 23, 2024 (CN) 202410096953.6

(51) Int. Cl. H04B 7/06; H04W 72/21

(52) U.S. Cl. CPC H04B 7/0626; H04W 72/21

(57) ABSTRACT

The disclosure relates to a 5G or 6G communication system for supporting a higher data transmission rate. The disclosure provides a method performed by a user equipment UE in a wireless communication system, the method including: receiving channel state information CSI report configuration, where the CSI report configuration includes a plurality of first sub-configurations; and when a first condition is satisfied, determining and/or report a CSI parameter based on a second sub-configuration, where the second sub-configuration includes at least one of the plurality of first sub-configurations; where the CSI parameter corresponds to a resource configured for interference measurement and associated with the second sub-configuration, where the resource configured for interference measurement is determined based on a resource configured for channel measurement and corresponding to the CSI parameter, or the resource configured for interference measurement includes a resource indicated by a second resource parameter.

### TECHNICAL FIELD

The application relates to the technical field of wireless communication, and in particular, to a method and a device for receiving and transmitting information.

### BACKGROUND ART

Fifth generation (5G) mobile communication technologies define broad frequency bands such that high transmission rates and new services are possible, and can be implemented not only in “sub 6 gigahertz (GHz)” bands such as 3.5 GHz, but also in “above 6 GHz” bands referred to as millimeter wave (mmWave) including 28 GHz and 39 GHz. In addition, implementing sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies is being considered.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multi input multi output (MIMO) for mitigating radio-wave path loss and increasing radio-wave transmission distances in mmWave. In addition, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amounts of data transmission and a polar code for highly reliable transmission of control information, layer two (L2) pre-processing, and network slicing for providing a dedicated network specialized to a specific service are also being used to support services and to satisfy performance requirements.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) technologies for aiding driving determination by autonomous vehicles based on information regarding positions and states of vehicles transmitted by the vehicles and for enhancing user convenience, new radio unlicensed (NR-U) technologies aimed at system operations conforming to various regulation-related requirements in unlicensed bands, new radio (NR) user equipment (UE) power saving technologies, non-terrestrial network (NTN) technologies, which are UE-satellite direct communication technologies for providing coverage in an area in which communication with terrestrial networks is unavailable, and positioning technologies.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (for example, 2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices will be connected to communication networks, and it is expected that enhanced functions and performances of 5G mobile communication systems and integrated operations of connected devices will be necessary. To this end, new research is scheduled in connection with extended Reality (XR) for efficiently supporting augmented reality (AR), virtual reality (VR), and mixed reality (MR). 5G performance improvement and complexity reduction may be accomplished by utilizing artificial intelligence (AI) and machine learning (ML), AI service support, metaverse service support, and drone communication.

Furthermore, such development of 5G mobile communication systems will serve as a basis for developing new waveforms for providing coverage in THz bands of 6G mobile communication technologies, multi-antenna transmission technologies such as full dimensional multiple input multiple output (FD-MIMO), array and large-scale antennas, metamaterial-based lenses and antennas for improving coverage of THz band signals, high-dimensional space multiplexing technology using orbital angular momentum (OAM), reconfigurable intelligent surface (RIS) technology, full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of 4G communication systems, efforts have been made to develop improved 5G or pre-5G communication systems. Therefore, 5G or pre-5G communication systems are also referred to as “beyond 4G networks” or “post-LTE systems”.

The 5G communication system is implemented at higher frequency bands (mmWave), such as the 60 GHz frequency band, for achieving higher data rates. To reduce radio wave propagation losses and increase transmission distances, techniques such as beamforming, massive multiple-input multiple-output (MIMO), full-dimensional MIMO (FD-MIMO), antenna arrays, analog beamforming, and massive antenna technology are being discussed in the context of 5G communication systems.

Moreover, in 5G communication systems, developments are underway to improve system networks based on advanced small cells, cloud radio access networks (RAN), ultra-dense networks, device-to-device (D2D) communication, wireless backhaul, mobile networks, cooperative communication, coordinated multi-point (COMP), and receiver interference cancellation.

In 5G systems, advanced coding modulation (ACM) schemes such as hybrid FSK and QAM (FQAM) and sliding window superposition coding (SWSC), as well as advanced access techniques such as filter bank multi-carrier (FBMC), non-orthogonal multiple access (NOMA), and sparse code multiple access (SCMA) have been developed.

The transmission from base stations to user equipment (UE) is known as the downlink, while the transmission from UE to base stations is referred to as the uplink.

### DISCLOSURE OF INVENTION

### Technical Problem

In order to enhance the scheduling efficiency of 5G wireless communication systems, a base station needs to obtain channel state information (CSI) for scheduling according to the CSI fed back by a terminal device. However, it is still problematic to further enhance the performance of CSI report.

### Solution to Problem

An aspect of the disclosure provides a method performed by a terminal in a wireless communication system. The method comprises receiving, from a base station, a channel state information (CSI) report configuration containing a list of sub-configurations; and transmitting, to the base station, CSI based on the CSI report configuration, wherein, in case that a report quantity for the CSI report configuration is not set to none and the CSI corresponds to a periodic CSI report, the periodic CSI report occupies CSI processing unit (CPU) from a first symbol of an earliest one of each of resources associated with all configured sub-configurations for the periodic CSI report corresponding to the list of sub-configurations, until a last symbol of a configured physical uplink shared channel (PUSCH) or physical uplink control channel (PUCCH) carrying the periodic CSI report, and wherein, in case that the report quantity for the CSI report configuration is not set to none and the CSI corresponds to a semi-persistent CSI report, the semi-persistent CSI report occupies CPU from a first symbol of an earliest one of each of resources associated with all configured sub-configurations for the semi-persistent CSI report corresponding to the list of sub-configurations, until a last symbol of a configured PUSCH or PUCCH carrying the semi-persistent CSI report.

Another aspect of the disclosure provides a method performed by a base station in a wireless communication system. The method comprises transmitting, to a terminal, a channel state information (CSI) report configuration containing a list of sub-configurations and receiving, from the terminal, CSI based on the CSI report configuration, wherein, in case that a report quantity for the CSI report configuration is not set to none and the CSI corresponds to a periodic CSI report, the periodic CSI report occupies CSI processing unit (CPU) from a first symbol of an earliest one of each of resources associated with all configured sub-configurations for the periodic CSI report corresponding to the list of sub-configurations, until a last symbol of a configured physical uplink shared channel (PUSCH) or physical uplink control channel (PUCCH) carrying the periodic CSI report, and wherein, in case that the report quantity for the CSI report configuration is not set to none and the CSI corresponds to a semi-persistent CSI report, the semi-persistent CSI report occupies CPU from a first symbol of an earliest one of each of resources associated with all configured sub-configurations for the semi-persistent CSI report corresponding to the list of sub-configurations, until a last symbol of a configured PUSCH or PUCCH carrying the semi-persistent CSI report.

Another aspect of the disclosure provides a terminal in a wireless communication system. The terminal comprises a transceiver and at least one processor configured to receive, from a base station, a channel state information (CSI) report configuration containing a list of sub-configurations, and to transmit, to the base station, CSI based on the CSI report configuration, wherein, in case that a report quantity for the CSI report configuration is not set to none and the CSI corresponds to a periodic CSI report, the periodic CSI report occupies CSI processing unit (CPU) from a first symbol of an earliest one of each of resources associated with all configured sub-configurations for the periodic CSI report corresponding to the list of sub-configurations, until a last symbol of a configured physical uplink shared channel (PUSCH) or physical uplink control channel (PUCCH) carrying the periodic CSI report, and wherein, in case that the report quantity for the CSI report configuration is not set to none and the CSI corresponds to a semi-persistent CSI report, the semi-persistent CSI report occupies CPU from a first symbol of an earliest one of each of resources associated with all configured sub-configurations for the semi-persistent CSI report corresponding to the list of sub-configurations, until a last symbol of a configured PUSCH or PUCCH carrying the semi-persistent CSI report.

Another aspect of the disclosure provides a base station in a wireless communication system. The base station comprises a transceiver and at least one processor configured to transmit, to a terminal, a channel state information (CSI) report configuration containing a list of sub-configurations, and to receive, from the terminal, CSI based on the CSI report configuration, wherein, in case that a report quantity for the CSI report configuration is not set to none and the CSI corresponds to a periodic CSI report, the periodic CSI report occupies CSI processing unit (CPU) from a first symbol of an earliest one of each of resources associated with all configured sub-configurations for the periodic CSI report corresponding to the list of sub-configurations, until a last symbol of a configured physical uplink shared channel (PUSCH) or physical uplink control channel (PUCCH) carrying the periodic CSI report, and wherein, in case that the report quantity for the CSI report configuration is not set to none and the CSI corresponds to a semi-persistent CSI report, the semi-persistent CSI report occupies CPU from a first symbol of an earliest one of each of resources associated with all configured sub-configurations for the semi-persistent CSI report corresponding to the list of sub-configurations, until a last symbol of a configured PUSCH or PUCCH carrying the semi-persistent CSI report.

Another aspect of the disclosure provides a method performed by a user equipment (UE) in a wireless communication system, the method including: receiving channel state information (CSI) report configuration, where the CSI report configuration includes a plurality of first sub-configurations; and when a first condition is satisfied, determining and/or report a CSI parameter based on a second sub-configuration, where the second sub-configuration includes at least one of the plurality of first sub-configurations; where the CSI parameter corresponds to a resource configured for interference measurement and associated with the second sub-configuration, where the resource configured for interference measurement is determined based on a resource configured for channel measurement and corresponding to the CSI parameter, or the resources configured for interference measurement includes a resource indicated by a second resource parameter included in the second sub-configuration; where the first condition includes at least one of the following: the plurality of first sub-configurations include a parameter configured for indicating a type 2; the plurality of first sub-configurations have a same channel state information reference signal (CSI-RS) port; the plurality of first sub-configurations include a parameter that indicates a resource configured for channel measurement and/or interference measurement; the number of resources configured for channel measurement and associated with the second sub-configurations is greater than 1; the CSI report configuration indicates an aperiodic CSI report, a semi-persistent CSI report, or an aperiodic CSI report; and the resource configured for channel measurement and/or for interference measurement and associated with the plurality of first sub-configurations is aperiodic.

Another aspect of the disclosure provides a method performed by a base station in a wireless communication system, the method including: transmitting channel state information (CSI) report configuration, where the CSI report configuration includes a plurality of first sub-configurations; and when a first condition is satisfied, receiving a CSI parameter reported by a user equipment (UE), where the CSI parameter is determined based on a second sub-configuration, the second sub-configuration includes at least one of the plurality of first sub-configurations; where the CSI parameter corresponds to a resource configured for interference measurement and associated with the second sub-configuration, where the resource configured for interference measurement is determined based on a resource configured for channel measurement and corresponding to the CSI parameter, or the resources configured for interference measurement includes a resource indicated by a second resource parameter; where the first condition includes at least one of the following: the plurality of first sub-configurations include a parameter configured for indicating a type 2; the plurality of first sub-configurations have a same channel state information reference signal (CSI-RS) port; the plurality of first sub-configurations include a parameter that indicates a resource configured for channel measurement and/or interference measurement; the number of resources configured for channel measurement and associated with the second sub-configurations is greater than 1; the CSI report configuration indicates an aperiodic CSI report, a semi-persistent CSI report, or an aperiodic CSI report; and the resource configured for channel measurement and/or for interference measurement and associated with the plurality of first sub-configurations is aperiodic.

In one example, the CSI parameter corresponds to the resource configured for channel measurement, where when the CSI report configuration corresponds to a plurality of resource sets configured for channel measurement: the resources configured for channel measurement are indicated by a plurality of first resource parameters included in the second sub-configuration, optionally, the resources configured for channel measurement are indicated by a first resource parameter and a first resource set indication parameter included in the second sub-configuration, where the first resource set indication parameter is configured to indicate one of the plurality of resource sets configured for channel measurement, and the first resource parameter is configured for indicating one or more resources in the resource set indicated by the first resource set indication parameter

In one example, the plurality of resource sets configured for channel measurement correspond to the plurality of first resource parameters in a one-to-one correspondence.

In one example, when the CSI report configuration corresponds to a plurality of resource sets configured for interference measurement: the resources configured for interference measurement are indicated by a plurality of second resource parameters included in the second sub-configuration; optionally, the resources configured for interference measurement are indicated by a second resource parameter and a second resource set indication parameter included in the second sub-configuration, where the second resource set indication parameter is configured to indicate one of the plurality of resource sets configured for interference measurement, and the second resource parameter is configured for indicating one or more resources in the resource set indicated by the second resource set indication parameter.

In one example, the plurality of resource sets configured for interference measurement correspond to the plurality of second resource parameters in a one-to-one correspondence.

In one example, in the case that the CSI parameter is a channel state information reference signal resource indicator (CRI), and a CRI value corresponding to the resource indicated by the first resource parameter included in the second sub-configuration is equal to a CRI value corresponding to the resource indicated by the second resource parameter that corresponds to indication of the first resource parameter and is included in the second sub-configuration, the channel quality indicator (CQI) corresponding to the CRI is computed based on the resource indicated by the first resource parameter and the resource indicated by the second resource parameter.

In one example, the number of resources in the resource set configured for interference measurement and corresponding to the CSI report configuration is equal to the total number of resources configured for channel measurement and associated with the plurality of first sub-configurations; and/or the order of resources in the resource set configured for interference measurement and corresponding to the CSI report configuration is determined based on the order of the plurality of first sub-configurations.

In one example, the number of resources configured for channel measurement and associated with the plurality of first sub-configurations is the total number of resources configured for channel measurement associated with the plurality of first sub-configurations and in the resource set that is configured for channel measurement and corresponds to the resource set configured for interference measurement.

In one example, the order of resources in the resource set configured for interference measurement and corresponding to the CSI report configuration is: the order of resources in the resource set configured for the interference measurement in the resource set, or the order of resource identifiers (IDs) of the resources in the resource set configured for the interference measurement; and/or, the order of the plurality of first sub-configurations is the order of IDs of the plurality of first sub-configurations, or the order of the plurality of first sub-configurations in the CSI report configuration.

In one example, the resource configured for interference measurement and associated with the second sub-configuration includes: a resource at a first position in the resource set configured for interference measurement and corresponding to the CSI report configuration, where the first position is the same as the position of the resource configured for channel measurement and associated with the second sub-configuration in the resource set configured for channel measurement and corresponding to the CSI report configuration.

In one example, the number of resources configured for interference measurement is equal to the number of resources configured for channel measurement and indicated by the first resource parameter included in the second sub-configuration.

In one example, in the case that the CSI parameter is a CRI, and a CRI value corresponding to the reference signal configured for channel measurement and associated with the second sub-configuration is equal to a CRI value corresponding to the reference signal configured for interference measurement and associated with the second sub-configuration, the reference signal configured for channel measurement and associated with the second sub-configuration are type-D quasi-colocated with the reference signal configured for interference measurement and associated with the second sub-configuration.

In one example, the second sub-configuration is indicated by a signaling that triggers a CSI report that corresponds to the CSI report configuration.

In one example, in the case that the second sub-configuration includes a first resource set indication parameter and/or a second resource set indication parameter, parameters associated with the triggering state indicated by the signaling do not include a parameter for selecting a resource set configured for interference measurement and/or channel measurement and corresponding to the CSI report configuration.

In one example, the number of resource sets configured for interference measurement and/or channel measurement and corresponding to the CSI report configuration is 1. In one example, in the case that the UE is configured with a CSI aperiodic triggering state list parameter, the CSI aperiodic triggering state list parameter includes a CSI-related report configuration information parameter associated with the CSI report configuration; and when a fourth condition is satisfied, the CSI-related report configuration information parameter does not include at least one of a channel resource parameter, a resource group parameter, a quasi co-location (QCL) information parameter, a CSI interference measurement (CSI-IM) resource parameter, and a non-zero power CSI-RS (NZP CSI-RS) resource parameter, where the fourth condition includes at least one of the following: the first sub-configuration includes at least one of the first resource set indication parameter and the second resource set indication parameter; the second sub-configuration includes at least one of the first resource set indication parameter and the second resource set indication parameter.

Another aspect of the disclosure provides a user equipment, including: a transceiver; and a controller coupled to the transceiver and configured to perform the above method that may be performed by the user equipment.

Yet another aspect of the disclosure provides a base station, including: a transceiver; and a controller coupled to the transceiver and configured to perform the above method that may be performed by the controller.

The method proposed in the present application improves the CSI performance, which further improves the scheduling efficiency of a communication system.

### Advantageous Effects of Invention

According to an embodiments of the disclosure a method and a device for processing CSI is provided.

### BRIEF DESCRIPTION OF DRAWINGS

When combined with the accompanying figures, the above and other aspects, features and advantages of the disclosure will become more apparent from the following detailed description.

FIG. 1 illustrates an overall structure of an example wireless communication network according to various embodiments of the disclosure;

FIGS. 2a and 2b illustrate a transmission path 200 and a reception path 250 in a wireless communication network in accordance with various embodiments of the disclosure;

FIG. 3a and FIG. 3b illustrate structures of a user equipment UE and a base station in a wireless communication network according to various embodiments of the disclosure;

FIG. 4 illustrates a method 400 performed by a UE in accordance with various embodiments of the disclosure;

FIG. 5 illustrates a method 500 performed by a base station in accordance with various embodiments of the disclosure;

FIG. 6 illustrates a structure 600 of a user equipment in accordance with various embodiments of the disclosure; and

FIG. 7 illustrates a structure 700 of a base station in accordance with various embodiments of the disclosure.

### MODE FOR THE INVENTION

Hereinafter, embodiments of the disclosure will be described in detail with reference to the accompanying drawings. It should be noted that in the drawings, the same or similar elements are preferably denoted by the same or similar reference numerals. In addition, detailed descriptions of known functions or configurations that may make the subject matter of the disclosure unclear will be omitted.

When describing the embodiments of the disclosure, descriptions related to technical content that is well known in the field and not directly related to the disclosure will be omitted. Such omission of unnecessary descriptions is to prevent obscuring the main idea of the disclosure and to convey the main idea more clearly.

For the same reason, in the drawings, certain elements may be enlarged, omitted, or schematically represented. Additionally, the size of each element does not necessarily reflect its actual size. In the drawings, the same or corresponding elements have the same reference numerals.

By referring to the detailed description of the embodiments provided below in conjunction with the accompanying drawings, the advantages and features of the disclosure, as well as the manner of implementing them, will become apparent. However, the disclosure is not limited to the embodiments described below, but can be implemented in various different forms. The following embodiments are provided solely for the purpose of fully disclosing the disclosure and informing those skilled in the art about the scope of the disclosure, and the disclosure is only limited by the claims appended hereto. Throughout the specification, the same or similar reference numerals indicate the same or similar elements.

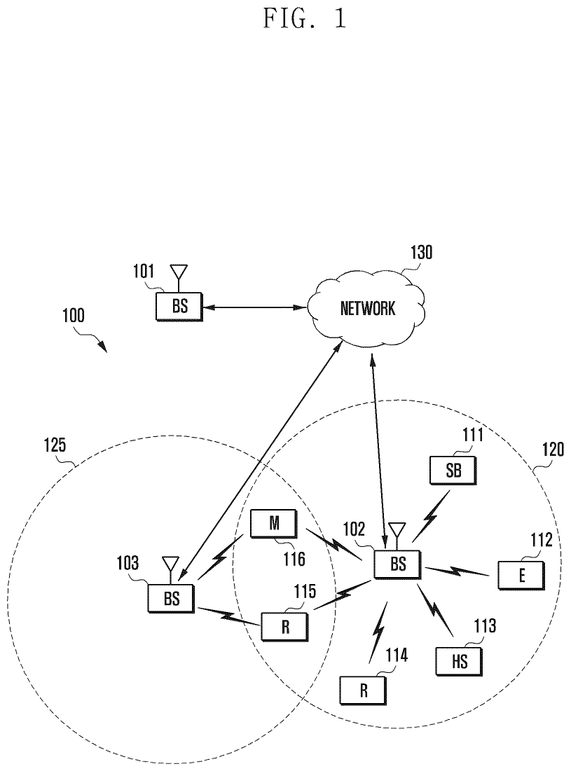

FIG. 1 illustrates an example wireless communication network 100 according to various embodiments of the disclosure. The embodiment of the wireless communication network 100 shown in FIG. 1 is for illustration only. Other embodiments of the wireless communication network 100 may be used without departing from the scope of this disclosure.

The wireless communication network 100 includes a gNodeB (gNB) 101, a gNB 102 and a gNB 103. The gNB 101 communicates with the gNB 102 and the gNB 103. The gNB 101 also communicates with at least one Internet Protocol (IP) network 130, such as the Internet, a proprietary IP network or other data networks.

Depending on the type of network, other well-known terms such as “base station (BS)” or “access point (AP)” can be used instead of “gNodeB” or “gNB”. For convenience, the terms “gNodeB” and “gNB” are used in this disclosure to refer to network infrastructure components that provide wireless access for remote terminals. In addition, depending on the type of network, other well-known terms such as “mobile station”, “user station”, “remote terminal”, “wireless terminal” or “user device” can be used instead of “user equipment” or “UE”. For convenience, the terms “user equipment” and “UE” are used in the disclosure to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to a network 130 for a first plurality of UEs within a coverage area 120 of the gNB 102. The first plurality of UEs include a UE 111 that can be located in a small business (SB), a UE 112 that can be located in an enterprise (E), a UE 113 that can be located in a WiFi hotspot (HS), a UE 114 that can be located in a first residence (R), a UE 115 that can be located in a second residence (R), and a UE 116 that can be a mobile device (M) such as a cellular phone, a wireless laptop computer, and a wireless PDA. The gNB 103 provides wireless broadband access to the network 130 for a second plurality of UEs within a coverage area 125 of the gNB 103. The second plurality of UEs include a UE 115 and a UE 116. In some embodiments, one or more of the gNBs 101-103 can communicate with each other and with the UE 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles for illustration and explanation purposes only. It should be clearly understood that coverage areas associated with gNBs, such as the coverage areas 120 and 125, can have other shapes, including irregular shapes, depending on the configuration of gNBs and changes in the radio environment associated with natural obstacles and man-made obstacles.

As described in more detail below, one or more of the gNB 101, the gNB 102, and the gNB 103 include a 2D antenna array as described in embodiments of the disclosure. In some embodiments, one or more of the gNB 101, the gNB 102 and the gNB 103 support a codebook design and structure for systems with 2D antenna arrays. Although FIG. 1 shows an example of the wireless communication network 100, various changes can be made to FIG. 1. For example, the wireless communication network 100 can include any number of gNBs and UEs in any suitable arrangement. Moreover, the gNB 101 can directly communicate with any number of UEs and provide the UEs with wireless broadband access to the network 130. Similarly, each of gNB 102-103 can communicate directly with the network 130 and provide the UE with direct wireless broadband access to the network 130. In addition, the gNB 101, the gNB 102 and/or the gNB 103 can provide access to other or additional external networks, such as external telephone networks or other types of data networks.

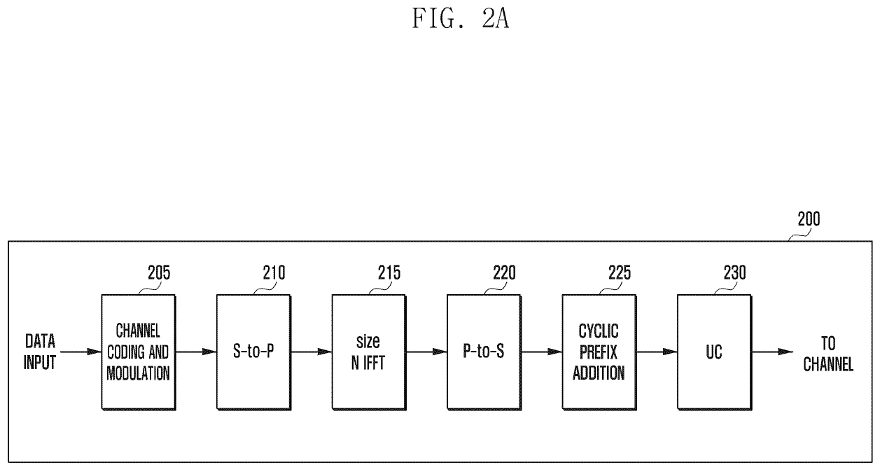

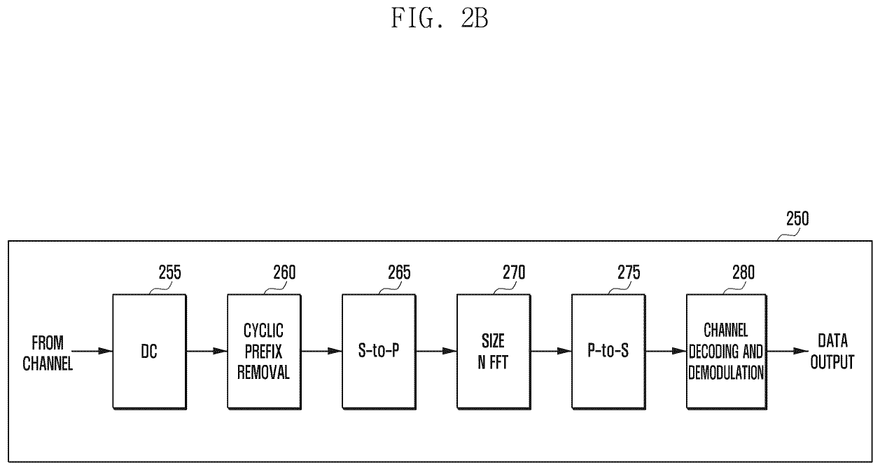

FIGS. 2a and 2b respectively illustrate a transmission path 200 and a reception path 250 in a wireless communication network according to various embodiments of the disclosure. In the following description, the transmission path 200 can be described as being implemented in a gNB, such as the gNB 102, and the reception path 250 can be described as being implemented in a UE, such as the UE 116. However, it should be understood that the reception path 250 can be implemented in a gNB and the transmission path 200 can be implemented in a UE. In some embodiments, the reception path 250 is configured to support a codebook design and a structure for a system having the 2D antenna array as described in the embodiments of the disclosure.

The transmission path 200 includes a channel coding and modulation block 205, a serial-to-parallel (S to P) block 210, an N-point inverse Fast Fourier Transform (IFFT) block 215, a parallel-to-serial (P to S) block 220, a cyclic prefix adding block 225, and an upconverter (UC) 230. The reception path 250 includes a downconverter (DC) 255, a cyclic prefix removal block 260, a serial-to-parallel (S to P) block 265, an N-point Fast Fourier Transform (FFT) block 270, a parallel-to-serial (P to S) block 275, and a channel decoding and demodulation block 280.

In the transmission path 200, the channel coding and modulation block 205 receives a set of information bits, applies coding such as low-density parity-check (LDPC) coding, and modulates the input bits (such as using quadrature phase shift keying (QPSK) or quadrature amplitude modulation (QAM)) to generate a sequence of frequency domain modulation symbols. The S to P block 210 converts (such as demultiplexes) serial modulation symbols into parallel data to generate N parallel symbol streams, where N is the number of IFFT/FFT points used in the gNB 102 and the UE 116. The N-point IFFT block 215 performs an IFFT operation on the N parallel symbol streams to generate a time domain output signal. The P to S block 220 converts (such as multiplexes) the parallel time domain output symbols from the N-point IFFT block 215 to generate a serial time domain signal. The cyclic prefix adding block 225 inserts a cyclic prefix into the time domain signal. The upconverter 230 modulates (such as upconverts) an output of the cyclic prefix adding block 225 into an RF for transmission via a wireless channel. The signal can also be filtered at a baseband before frequency conversion to the RF.

An RF signal transmitted from the gNB 102 reaches the UE 116 after passing through the wireless channel, and an operation opposite to that at the gNB 102 is performed at the UE 116. The downconverter 255 downconverts a received signal to a baseband frequency, and the cyclic prefix removal block 260 removes the cyclic prefix to generate a serial time domain baseband signal. The S to P block 265 converts the time domain baseband signal into a parallel time domain signal. The N-point FFT block 270 performs an FFT algorithm to generate N parallel frequency domain signals. The P to S block 275 converts the parallel frequency domain signal into a sequence of modulation data symbols. The channel decoding and demodulation block 280 demodulates and decodes the modulation symbols to recover an original input data stream.

Each of the gNBs 101-103 may implement a transmission path 200 similar to transmitting to the UE 111-116 in a downlink, and may implement a reception path 250 similar to receiving from the UE 111-116 in an uplink. Similarly, each of the UEs 111-116 may implement a transmission path 200 for transmitting to the gNBs 101-103 in an uplink, and may implement a reception path 250 for receiving from the gNBs 101-103 in a downlink.

Each of the components in FIGS. 2a and 2b can be implemented using only hardware or using a combination of hardware and software/firmware. As a specific example, at least some of the components in FIGS. 2a and 2b may be implemented by software, while other components may be implemented by configurable hardware or a combination of software and configurable hardware. For example, the FFT block 270 and the IFFT block 215 may be implemented as configurable software algorithms, and the value of the number of points N may be modified according to the specific implementation.

Further, although described as using FFT and IFFT, this is merely illustrative and should not be interpreted as limiting the scope of the disclosure. Other types of transforms can be used, such as discrete Fourier transform (DFT) and inverse discrete Fourier transform (IDFT) functions. It should be understood that for DFT and IDFT functions, the value of the variable N can be any integer (such as 1, 2, 3, 4, etc.), while for FFT and IFFT functions, the value of the variable N can be any integer which is a power of 2 (such as 1, 2, 4, 8, 16, etc.).

Although FIGS. 2a and 2b show examples of wireless transmission and reception paths, various changes can be made to FIGS. 2a and 2b. For example, various components in FIGS. 2a and 2b can be combined, further subdivided or omitted, and additional components can be added according to specific needs. Furthermore, FIGS. 2a and 2b are intended to show examples of types of transmission and reception paths that can be used in a wireless network. Any other suitable architecture may be used to support wireless communication in a wireless network.

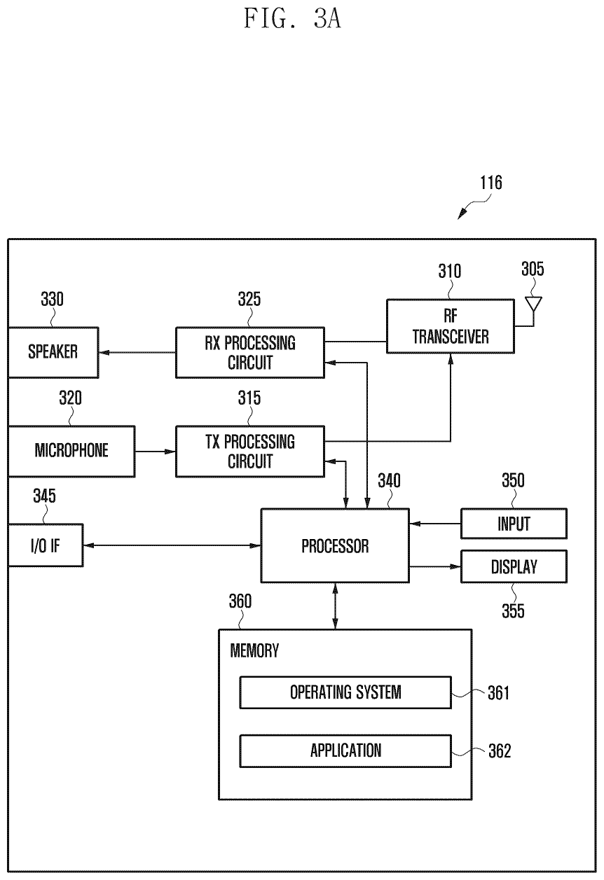

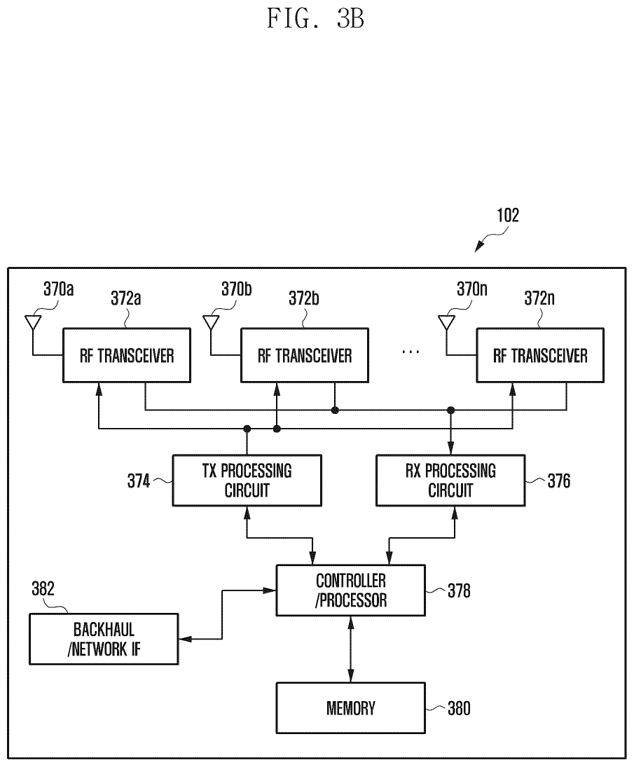

FIG. 3a illustrates an example UE 116 according to various embodiments of the disclosure. The embodiment of the UE 116 shown in FIG. 3a is for illustration only, and the UE 111-115 of FIG. 1 can have the same or similar configurations. However, the UE has various configurations, and FIG. 3a does not limit the scope of the disclosure to any specific implementation of the UE.

The UE 116 includes an antenna 305, a radio frequency (RF) transceiver 310, a transmit (TX) processing circuit 315, a microphone 320 and a receive (RX) processing circuit 325. The UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by the gNB of the wireless network 100 from the antenna 305. The RF transceiver 310 downconverts the incoming RF signal to generate an intermediate frequency (IF) or baseband signal. The IF or baseband signal is sent to the RX processing circuit 325, which generates a processed baseband signal by filtering, decoding and/or digitizing the baseband or IF signal. The RX processing circuit 325 sends the processed baseband signal to the speaker 330 (such as for voice data) or to the processor/controller 340 (such as for network browsing data) for further processing.

The TX processing circuit 315 receives analog or digital voice data from the microphone 320 or other outgoing baseband data (such as network data, e-mail or interactive video game data) from the processor/controller 340. The TX processing circuit 315 encodes, multiplexes, and/or digitizes the outgoing baseband data to generate a processed baseband or IF signal. The RF transceiver 310 receives an outgoing processed baseband or IF signal from the TX processing circuit 315 and upconverts the baseband or IF signal into an RF signal transmitted via the antenna 305.

The processor/controller 340 can include one or more processors or other processing devices and execute an OS 361 stored in the memory 360 in order to control the overall operation of the UE 116. For example, the processor/controller 340 can control the reception of a forward channel signal and the transmission of a backward channel signal through the RF transceiver 310, the RX processing circuit 325 and the TX processing circuit 315 according to well-known principles. In some embodiments, the processor/controller 340 includes at least one microprocessor or microcontroller.

The processor/controller 340 can also execute other processes and programs residing in the memory 360, such as operations for channel quality measurement and report of a system having the 2D antenna array as described in the embodiment of the disclosure. The processor/controller 340 can move data into or out of the memory 360 as required by the execution process. In some embodiments, the processor/controller 340 is configured to execute the application 362 based on the OS 361 or in response to a signal received from the gNB or a carrier. The processor/controller 340 is further coupled to the I/O interface 345, which provides the UE 116 with the ability to connect to other devices, such as laptop deterministic machines and handheld deterministic machines. The I/O interface 345 is a communication path between these accessories and the processor/controller 340.

The processor/controller 340 is further coupled to the input device(s) 350 and the display 355. An operator of the UE 116 can input data into the UE 116 using the input device(s) 350. The display 355 may be a liquid crystal display or other displays capable of presenting texts and/or at least limited graphics (such as from a website). The memory 360 is coupled to the processor/controller 340. A part of the memory 360 can include a random access memory (RAM), and another part of the memory 360 can include a flash memory or other read-only memories (ROM).

Although FIG. 3a illustrates an example of the UE 116, various changes may be made to FIG. 3a. For example, various components in FIG. 3a can be combined, further subdivided or omitted, and additional components can be added according to specific needs. As a specific example, the processor/controller 340 can be divided into a plurality of processors, such as one or more central processing units (CPU) and one or more graphics processing units (GPU). Further, although FIG. 3a shows the UE 116 configured as a mobile phone or a smart phone, the UE can be configured to operate as other types of mobile or fixed devices.

FIG. 3b illustrates an example gNB 102 according to various embodiments of the disclosure. The embodiment of the gNB 102 shown in FIG. 3b is for illustration only, and other gNBs of FIG. 1 can have the same or similar configurations. However, the gNB has various configurations, and FIG. 3b does not limit the scope of the disclosure to any specific implementation of the gNB. It should be noted that the gNB 101 and the gNB 103 may include the same or similar structures as the gNB 102.

As shown in FIG. 3b, the gNB 102 includes a plurality of antennas 370a-370n, a plurality of RF transceivers 372a-372n, a transmit (TX) processing circuit 374 and a receive (RX) processing circuit 376. In some embodiments, one or more of the plurality of antennas 370a-370n include a 2D antenna array. The gNB 102 also includes a controller/processor 378, a memory 380 and a backhaul or network interface 382.

The RF transceivers 372a-372n receive incoming RF signals from the antennas 370a-370n, such as signals transmitted by the UE or other gNBs. The RF transceivers 372a-372n downconvert the incoming RF signals to generate IF or baseband signals. The IF or baseband signals are sent to the RX processing circuit 376, which generates processed baseband signals by filtering, decoding and/or digitizing the baseband or IF signals. The RX processing circuit 376 sends the processed baseband signals to the controller/processor 378 for further processing.

The TX processing circuit 374 receives analog or digital data (such as voice data, network data, e-mail or interactive video game data) from the controller/processor 378. The TX processing circuit 374 encodes, multiplexes and/or digitizes outgoing baseband data to generate processed baseband or IF signals. The RF transceivers 372a-372n receive the processed baseband or IF signals from the TX processing circuit 374 and upconvert the baseband or IF signals into RF signals transmitted via the antennas 370a-370n.

The controller/processor 378 may include one or more processors or other processing devices that control the overall operation of the gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as more advanced wireless communication functions. For example, the controller/processor 378 can perform a BIS process by means of, for example, a blind interference sensing (BIS) algorithm, and decode received signals from which interference signals are subtracted. The controller/processor 378 may support any of a variety of other functions in the gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and report for systems with the 2D antenna array as described in the embodiment of the disclosure. In some embodiments, the controller/processor 378 supports communication between entities such as web RTCs. The controller/processor 378 can move data into or out of the memory 380 as required by the execution process.

The controller/processor 378 is further coupled to the backhaul or network interface 382. The backhaul or network interface 382 allows the gNB 102 to communicate with other devices or systems through a backhaul connection or through a network. The backhaul or network interface 382 can support communication over any suitable wired or wireless connection(s). For example, when the gNB 102 is implemented as part of a cellular communication system (such as one that supports 5G or new radio access technology or NR, LTE or LTE-A), the backhaul or network interface 382 can allow the gNB 102 to communicate with other gNBs through wired or wireless backhaul connections. When the gNB 102 is implemented as an access point, the backhaul or network interface 382 can allow the gNB 102 to communicate with a larger network, such as the Internet, through a wired or wireless local area network or through a wired or wireless connection. The backhaul or network interface 382 includes any suitable structure that supports communication through wired or wireless connections, such as an Ethernet or RF transceiver.

The memory 380 is coupled to the controller/processor 378. A part of the memory 380 may include an RAM, and another part of the memory 380 may include a flash memory or other ROMs. In some embodiments, a plurality of instructions, such as the BIS algorithm, are stored in the memory. The plurality of instructions are configured to cause the controller/processor 378 to perform a BIS process and decode a received signal after subtracting at least one interference signal determined by the BIS algorithm.

As described in more detail below, the transmission and reception paths of the gNB 102 (implemented using the RF transceivers 372a-372n, the TX processing circuit 374 and/or the RX processing circuit 376) support aggregated communication with FDD cells and TDD cells.

Although FIG. 3b shows an example of the gNB 102, various changes can be made to FIG. 3b. For example, the gNB 102 may include any number of each component shown in FIG. 3b. As a specific example, the access point may include multiple backhaul or network interfaces 382, and the controller/processor 378 can support the routing function to route data between different network addresses. As another specific example, although shown as including a single instance of the TX processing circuit 374 and a single instance of the RX processing circuit 376, the gNB 102 may include multiple instances of each (such as one for each RF transceiver).

At present, in a wireless communication system, a user equipment (UE) can only obtain a power parameter and/or a spatial parameter change on the network device side in a semi-static way, which cannot meet the needs of flexible adjustment on the base station side.

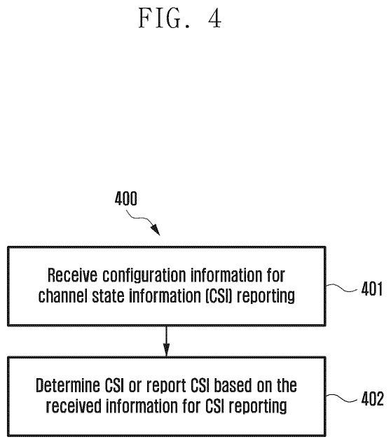

The various embodiments of the present application are described in detail below with reference to the accompanying drawings. FIG. 4 illustrates a method 400 performed by a user equipment (UE) in accordance with various embodiments of the disclosure. The method 400 includes: at 401, receiving, by the UE, configuration information for CSI report; and at 402, determining and/or report, by the UE, CSI based on the received configuration information for CSI report. As used herein, the term “information for a CSI report configuration” may be used interchangeably with the terms “information for CSI report configuration” and “information for configuring CSI report”.

### Embodiment 1

The UE receives the information for CSI report configuration (for example, CSI-ReportConfig). Optionally, the information for CSI report configuration is associated with/corresponds to/includes one or more first sub-configurations. The sub-configuration herein may be referred to as sub-configuration information. Optionally, a first sub-configuration may be sub-configuration information of CSI report.

Optionally, a second sub-configuration includes one or more of the first sub-configurations. Optionally, the second sub-configuration is (for example, one of, or any of, or each or all of) sub-configuration(s) from a plurality of first sub-configurations. For example, if the information for the CSI report configuration corresponds to periodic CSI report, the second sub-configuration is (for example, one of, or any of, or each of) one or more first sub-configurations. Optionally, when the information for the CSI report configuration corresponds to periodic CSI report, each reporting instance of the periodic CSI report is for all sub-configurations in one or more first sub-configurations. For example, the number of the one or more first sub-configurations may be L, where L>1 (or, L>=1). For example, the number of the one or more first sub-configurations may be L, where L>1 (or, L>=1). For example, where the second sub-configurations are all sub-configurations in a subset of the one or more first sub-configurations, the number of the second sub-configuration may be N, where N<=L and/or N>=1. Optionally, in the case that the CSI report is periodic CSI report, N=L. For example, the CSI report includes a CSI parameter corresponding to all sub-configurations in the one or more first sub-configurations. Optionally, the CSI report corresponding to periodic CSI report, refers to report type parameter (reportConfigType) in the information for the CSI report configuration (for example, CSI-ReportConfig) is set to “periodic”

Optionally, the second sub-configuration(s) includes a subset of the one or more first sub-configurations. Optionally, the second sub-configuration is (for example, one of, or any of, or each or all of) a subset of the one or more first sub-configurations. For example, when the information for the CSI report configuration corresponds to semi-persistent CSI report or aperiodic CSI report, the second sub-configuration(s) may be (for example, one of, or any of, or each or all of) a subset of the one or more first sub-configurations. For example, the number of the one or more first sub-configurations may be L, where L>1 (or, L>=1). For example, taking an example that the second sub-configuration(s) are all sub-configurations in a subset of the one or more first sub-configurations, the number of the second sub-configuration(s) may be N, where N<=L and/or N>=1. Optionally, the subset is indicated (or provided) by a signaling that triggers/activates/schedules/indicate a CSI report that corresponds to the information for the CSI report configuration. For example, if the CSI report configuration includes (or, is configured with) L sub-configuration(s), a signaling may trigger/activate/schedule/indicate CSI report that corresponds to the information for the CSI report configuration, and the signaling may indicate N sub-configuration(s) in the L sub-configuration(s) for CSI report. For example, UE generates/derives CSI (for example, a CSI parameter) corresponding to the N sub-configuration(s) in the L sub-configuration(s), and includes them into the CSI report. For example, if the information for the CSI report configuration corresponds to semi-persistent CSI report on physical uplink control channel (PUCCH), and the information for the CSI report configuration includes (or, is configured with) L sub-configuration(s), then a media access control-control element (MAC-CE) signaling may trigger a CSI report corresponding to the CSI report configuration (for example, the CSI report is carried by the PUCCH), and the MAC-CE signaling may include indication information for indicating N sub-configuration(s) from the L sub-configuration(s) for CSI report. For example, if the information for the CSI report configuration corresponds to a semi-persistent CSI report on a physical uplink shared channel (PUSCH), and the information for the CSI report configuration includes (or, is configured with) L sub-configuration(s), then downlink control information (DCI) (or a DCI format) may trigger a CSI report corresponding to the CSI report configuration (for example, the CSI report is carried by the PUSCH), and the DCI may indicate a triggering state. Optionally, the triggering state is associated with N sub-configuration(s) (in the L sub-configurations) (optionally, the triggering state may indicate N configuration(s)) for CSI report. Optionally, the DCI format may be a DCI format 0_1 or a DCI format 0_2. For example, if the information for the CSI report configuration corresponds to aperiodic CSI report, and the information for the CSI report configuration includes (or, is configured with) L sub-configuration(s), then downlink control information (DCI) (or a DCI format) may trigger a CSI report corresponding to the CSI report configuration (for example, the CSI report is carried by a PUSCH), and the DCI may indicate a triggering state. Optionally, the triggering state is associated with N sub-configurations (in the L sub-configurations) (optionally, the triggering state indicates N configuration(s)) for CSI report. Optionally, the DCI format may be DCI format 0_1 or DCI format 0_2. Optionally, the information for the CSI report configuration corresponding to a semi-persistent CSI report on a PUCCH, means that a report type parameter (reportConfigType) in the information for the CSI report configuration (for example, CSI-ReportConfig) is set to “a semi-persistent report on a PUCCH” (semiPersistentOnPUCCH). Optionally, the information for the CSI report configuration corresponding to semi-persistent CSI report on PUSCH, means that a report type parameter (reportConfigType) in the information for the CSI report configuration (for example, CSI-ReportConfig) is set to “a semi-persistent report on PUSCH” (semiPersistentOnPUSCH). Optionally, the information for the CSI report configuration corresponding to aperiodic CSI report, means that a report type parameter (reportConfigType) in the information for the CSI report configuration (for example, CSI-ReportConfig) is set to “aperiodic”.

Optionally, the description of the second sub-configuration(s) in the disclosure may be applicable to one sub-configuration of, or each sub-configuration of, or any sub-configuration of, one or more first sub-configurations. Optionally, the description of the second sub-configuration(s) in the disclosure may apply to one sub-configuration of, or each sub-configuration of, or any sub-configuration of, a subset of one or more first sub-configuration(s). Optionally, in the disclosure, second sub-configuration(s) may be equivalent to one or more first sub-configuration(s). Optionally, in the disclosure, second sub-configuration(s) may be equivalent to first sub-configuration(s).

Optionally, the UE determines CSI parameter based on the second sub-configuration(s). As used herein, the term “CSI parameter” may be used interchangeably with the term “parameter for CSI report”. Optionally, the determining CSI parameter may be computing CSI parameter. Optionally, the determining a CSI parameter may be determining CSI feedback. The determining CSI parameter may also be determining a report that carries CSI parameter (that is, determining CSI report). Optionally, the CSI parameter may be CSI feedback. The CSI parameter may also be a report that carries the CSI parameter (that is, CSI report).

Optionally, CSI parameter may be at least one of CSI-RS resource indicator (CRI), rank indicator (RI), precoding matrix indicator (PMI), channel quality indicator (CQI), layer indicator (LI). Optionally, the CSI parameter may be at least one of a CSI-RS resource indicator (CRI), SS/PBCH block resource indicator (SSBRI), Layer 1-reference signal receive power (L1-RSRP), Layer 1-signal interference-to-noise ratio (L1-SINR), and a capability index (CapabilityIndex).

Optionally, the UE determines second CSI parameter for the second sub-configuration(s) based on first CSI parameter for the second sub-configuration(s). Optionally, when first condition is satisfied, the UE determines second CSI parameter for the second sub-configuration based on first CSI parameter for the second sub-configuration. Optionally, when a first condition is satisfied, the UE determines the CSI parameter based on the second sub-configuration. Optionally, the first CSI parameter may be the CRI. Optionally, the first CSI parameter may be at least one of the RI, the PMI, the CQI, and the LI. Optionally, the second CSI parameter may be CSI parameter other than the first CSI parameter. Optionally, the second CSI parameter may be CSI parameter other than the CRI. Optionally, the second CSI parameter may be at least one of the RI, the PMI, the CQI, and the LI. Optionally, the first condition includes at least one of the following:
The second sub-configuration(s) is configured with/includes type 2 parameter. Optionally, the type 2 parameter is configured to indicate a type 2 adaptation.
(One or all of) one or more first sub-configuration(s) are configured with a type 2 parameter. Optionally, the type 2 parameter is configured to indicate a type 2 adaptation.
One or more first sub-configuration(s) are with the same CSI-RS port(s). Optionally, the CSI-RS port(s) refers to CSI-RS port(s) that corresponds to the number of port(s) parameter (for example, nrofPorts). Optionally, the CSI-RS port(s) may be CSI-RS port(s) configured for channel measurement. The CSI port(s) may be CSI-RS antenna port(s). Optionally, the CSI-RS port corresponds to resource(s) (for example, a reference signal resource) configured for channel measurement.
The second sub-configuration(s) includes/corresponds to/is associated with/indicates one or more resources. Optionally, the one or more resources are configured for channel measurement and/or interference measurement. Optionally, the one or more resources are reference signal resources configured for channel measurement. Optionally, the one or more resources are reference signal resources configured for interference measurement. Optionally, the second sub-configuration includes/corresponds to/is associated with one or more lists, which respectively indicate one or more resources. Optionally, the one or more reference signal resources include reference signal resource(s) in a resource set (for example, NZP-CSI-RS-ResourceSet). Optionally, the one or more resources include resources in a resource set (for example, csi-IM-ResourceSet). Optionally, the resource set corresponds to the information for the CSI report configuration. For example, a resource set is in a CSI resource setting corresponding to the information for the CSI report configuration. For example, the CSI resource setting is CSI-ResourceConfig.
(One or all of) one or more first sub-configuration(s) include/correspond to/are associated with/indicate one or more resources. Optionally, the one or more resources are configured for channel measurement and/or interference measurement. Optionally, the second sub-configuration includes/corresponds to/is associated with one or more lists, which indicate one or more resources. Optionally, the one or more resources include reference signal resource(s) in a resource set (for example, NZP-CSI-RS-ResourceSet). Optionally, the one or more resources include resources in a resource set (for example, csi-IM-ResourceSet). Optionally, the resource set corresponds to the information for the CSI report configuration. For example, a resource set is in a CSI resource setting corresponding to the information for the CSI report configuration. For example, the CSI resource setting is CSI-ResourceConfig.
The number of resources configured for channel measurement for (or associated with) the second sub-configuration is greater than 1. Optionally, the number (or, total number) of reference signal resources configured for channel measurement for the second sub-configuration is greater than 1.
The CSI configuration information corresponds to one of aperiodic CSI report, semi-persistent CSI report, and periodic CSI report.
The resources configured for channel measurement and/or interference measurement for (associated with) the second sub-configuration(s) are aperiodic. Optionally, a resource type parameter (for example, resourceType) of the CSI resource setting (CSI-ResourceConfig) (configured for channel measurement and/or interference measurement) for the second sub-configuration(s) and corresponding to the information for the CSI report configuration is set to “aperiodic”.
(One or all of) one or more first sub-configuration(s) include/correspond to/are associated with/indicate that the resources configured for channel measurement and/or for interference measurement are aperiodic. Optionally, a resource type parameter (for example, resourceType) of the CSI resource setting (CSI-ResourceConfig) (configured for channel measurement and/or interference measurement) for the second sub-configuration(s) and corresponding to the information for the CSI report configuration is set to “aperiodic”.

Optionally, the first CSI parameter corresponds to resource(s) configured for channel measurement for the second sub-configuration and/or a resource configured for interference measurement for the second sub-configuration. The first CSI parameter is described herein by taking CRI as an example. The CRI (or a CRI value) is represented by a parameter k. Optionally, k is a integer greater than or equal to 0 (k>=0). For example, different k values represent different resources configured for channel measurement and/or for interference measurement. Optionally, the (reported) CRI corresponding to the second sub-configuration corresponds to a resource (for example, a reference signal resource) configured for channel measurement for the second sub-configuration. Optionally, when the number of resources configured for channel measurement for the second sub-configuration is greater than 1, the CRI corresponding to the second sub-configuration is reported. Optionally, when the number of resources configured for channel measurement for the second sub-configuration is equal to 1, the value of the CRI corresponding to the second sub-configuration may be (or, may be regarded as) a specific value (for example, 0 or 1).

Optionally, the resource configured for channel measurement for the second sub-configuration includes/refers to the resource indicated by the first resource parameter included in/associated with the second sub-configuration. Optionally, the second sub-configuration may include a first resource parameter. Optionally, the first resource parameter is configured to indicate one or more resources configured for channel measurement. Optionally, the first resource parameter may indicate one or more resources from the resource set (for example, NZP-CSI-RS-ResourceSet) that corresponds to/is associated with the information for the CSI report configuration. Optionally, the resource set corresponds to the information for the CSI report configuration. Optionally, a resource set is in a CSI resource setting corresponding to the information for the CSI report configuration. Optionally, the CSI resource setting is configured for channel measurement. For example, the CSI resource setting may be associated with/correspond to a channel measurement resource parameter (for example, resourcesForChannelMeasurement) in the CSI report configuration. For example, the CSI resource setting is a CSI-ResourceConfig parameter. The indication to a resource herein may be either an explicit indication or a direct indication. Optionally, the resource may be a reference signal resource. Optionally, the reference signal resource may be a reference signal. Optionally, the resource includes a CSI-RS resource or a channel state information interference measurement (CSI-IM) resource. Optionally, the CSI-RS may be a non-zero power (NZP) CSI-RS.

Optionally, a mapping between the first resource parameter and a resource indicated by it may be determined by one of the following methods:

### Method 1

The first resource parameter is a list. Optionally, one (or each) entry in the list indicates a resource identifier (ID) (for example, a CSI-RS resource ID). Optionally, the resource corresponding to the resource ID belongs to the resource set configured for channel measurement (for example, NZP-CSI-RS-ResourceSet) and corresponding to the information for the CSI report configuration. For example, if the resource set configured for channel measurement and corresponding to the information for the CSI report configuration is {CSI-RS#1, CSI-RS#3, CSI-RS#4, CSI-RS#7} and the first resource parameter indicates {#1, #7}, then the channel measurement resource corresponding to the second sub-configuration is {CSI-RS#1, CSI-RS#7}. A terminal device uses the reference signal resource corresponding to the resource ID indicated in the list to perform channel measurement (instead of using all reference signal resources in the resource set configured for channel measurement and corresponding to the information for the CSI report configuration).

### Method 2

The first resource parameter is a list. Optionally, one (or each) entry in the list indicates an index of a resource in a resource set. For example, a first resource in the resource set has an index 0, a second resource in the resource set has an index 1, and so on. Optionally, the resource set is/includes the resource set configured for channel measurement (for example, NZP-CSI-RS-ResourceSet) and corresponding to the information for the CSI report configuration. For example, if the resource set configured for channel measurement and corresponding to the information for the CSI report configuration is {CSI-RS#1, CSI-RS#3, CSI-RS#4, CSI-RS#7} and the first resource parameter indicates {0, 2}, then the channel measurement reference signal resource corresponding to the second sub-configuration is {CSI-RS#1, CSI-RS#4}. A terminal device uses the resource indicated in the list to perform channel measurement (instead of using all resources in the resource set configured for channel measurement and corresponding to the information for the CSI report configuration).

The above two methods may identify a mapping relationship between the first resource parameter and the corresponding resource, improving the reliability of the communication system.

Optionally, the first CSI parameter corresponding to a resource configured for channel measurement for the second sub-configuration, means that the first CSI parameter corresponds to a resource (for example, a reference signal resource) configured for channel measurement indicated by the first resource parameter for the second sub-configuration. As an example that the first CSI parameter is a CRI, there is a mapping relationship between the CRI and the resource configured for channel measurement indicated by the first resource parameter. The mapping relationship may be determined by at least one of the following methods:

### Method 1

The CRI is determined based on an order/position of the resource configured for channel measurement indicated by the first resource parameter in the resource set configured for channel measurement corresponding to the information for the CSI report configuration. Optionally, the k value corresponding to the CRI indicates the (k+1)th resource in the resource set configured for channel measurement and corresponding to the information for the CSI report configuration, as indicated by the first resource parameter. For example, if the resource set configured for channel measurement and corresponding to the information for the CSI report configuration is {CSI-RS#1, CSI-RS#3, CSI-RS#4, CSI-RS#7}, and the first resource parameter indicates CSI-RS#4 and CSI-RS#1, then k=0 corresponds to CSI-RS#1 and k=1 corresponds to CSI-RS#4.

### Method 2

The CRI is determined based on an order/position of the resource indicated by the first resource parameter configured for channel measurement in the first resource parameter. Optionally, the value k corresponding to the CRI represents the resource indicated by (k+1)th entry of the first resource parameter. For example, if the resource set configured for channel measurement and corresponding to the information for the CSI report configuration is {CSI-RS#1, CSI-RS#3, CSI-RS#4, CSI-RS#7}, and the first resource parameter indicates CSI-RS#4 and CSI-RS#1 (for example, CSI-RS#4 corresponds to the first entry of the first resource parameter; CSI-RS#1 corresponds to the second entry of the first resource parameter), then k=0 corresponds to CSI-RS#4 and k=1 corresponds to CSI-RS#1.

### Method 3

The CRI is determined based on an order (for example, a magnitude order) of the resource ID of the resource configured for channel measurement indicated by the first resource parameter. For example, the order is an ascending order or a descending order. Optionally, the resource ID may be a configured ID. Optionally, the value k corresponding to the CRI indicates the resource with the (k+1)th highest ID (or the (k+1)th lowest) ID among the resources indicated by the first resource parameter. As an example, where the value k corresponding to CRI indicates the resource with the k+1 lowest ID indicated by the first resource parameter, the resource set configured for channel measurement and corresponding to the information for the CSI report configuration is {CSI-RS#3, CSI-RS#1, CSI-RS#4, CSI-RS#7}, and the first resource parameter indicates {CSI-RS#3, CSI-RS#1, CSI-RS#4}, then k=0 corresponds to CSI-RS#1; k=1 corresponds to CSI-RS#3; and k=2 corresponds to CSI-RS#4.

For a sub-configuration, a terminal device may measure the resources indicated based on the first resource parameter, select at least one resource (for example, the resource with the highest signal-to-noise ratio) from them, and feedback the information of the resource to the base station. Defining the mapping relationship between the resource indicated by the first resource parameter and the CRI may avoid different understandings of the reported information between the terminal device and the base station. The above methods may identify the mapping relationship between the CRI (or k) and the corresponding resource, improving the reliability of the communication system.

Optionally, when a second condition is satisfied, the second sub-configuration includes/is associated with/corresponds to/indicates at least one of the following: a plurality of first resource parameters, or, a first resource parameter and/or a first resource set indication parameter. Optionally, the second condition includes at least one of the following:
The information for the CSI report configuration corresponds to a plurality of (aperiodic) resource sets. Optionally, the resource set may be configured for channel measurement and/or for interference measurement. Optionally, the resource setting configured for channel measurement and corresponding to (or associated with) the information for the CSI report configuration includes a plurality of (aperiodic) resource sets. For example, the CSI-ResourceConfig configured by the resourcesForChannelMeasurement parameter for CSI-ReportConfig includes a plurality of resource sets (for example, NZP-CSI-RS-ResourceSet).
The information for the CSI report configuration corresponds to an aperiodic resource set. Optionally, the resource set may be configured for channel measurement and/or for interference measurement. Optionally, the resource setting configured for channel measurement and corresponding to (or associated with) the information for the CSI report configuration includes an aperiodic resource set. For example, the CSI-ResourceConfig configured by the resourcesForChannelMeasurement parameter for CSI-ReportConfig includes a resource set (for example, NZP-CSI-RS-ResourceSet). For example, the resource type of the resource setting is aperiodic.
A UE is configured with a CSI aperiodic triggering state list parameter (CSI-AperiodicTriggerStateList).

Optionally, the second sub-configuration includes/is associated with/indicates a plurality of first resource parameters. Optionally, the information for the CSI report configuration corresponds to a plurality of resource sets (configured for channel measurement). Optionally, the number of the plurality of resource sets (configured for channel measurement) corresponding to the information for the CSI report configuration is equal to the number of the plurality of first resource parameters. Optionally, the plurality of resource sets configured for channel measurement and corresponding to the information for the CSI report configuration correspond to the plurality of first resource parameters in a one-to-one correspondence. Optionally, a one-to-one correspondence may be a one-to-one correspondence sequentially. Optionally, the order may be determined based on a (sequential) order/position of a plurality of resource sets configured for channel measurement in the resource setting and/or a (sequential) order/position of a plurality of first resource parameters in the corresponding list. For example, (the resource setting corresponding to) the information for the CSI report configuration includes three resource sets configured for channel measurement, which are {CSI-RS#1, CSI-RS#2, CSI-RS#3, CSI-RS#4}, {CSI-RS#5, CSI-RS#6}, and {CSI-RS#7, CSI-RS#8, CSI-RS#9, CSI-RS#10}, and the three first resource parameters respectively indicate {CSI-RS#1, CSI-RS#4}, {CSI-RS #6}, and {CSI-RS#9, CSI-RS#10}. The three resource sets correspond to the three first resource parameters in a one-to-one correspondence sequentially. Optionally, refer to the above description for the methods for using (each of) the first resource parameters.

Optionally, (for a CSI report), (only) one of the plurality of (aperiodic) resource sets in the resource setting is associated with a triggering state. Optionally, each triggering state for each resource setting may be configured with a parameter for selecting a resource set in the resource setting. Optionally, the UE receives a triggering signaling (for example, a DCI format) for an aperiodic CSI report. Optionally, the triggering signaling may indicate a triggering state. The UE may determine one of the plurality of (aperiodic) resource sets in the resource setting based on the parameter associated with the triggering state (optionally, a parameter configured for the triggering state). Optionally, the selected/indicated (aperiodic) resource set determines a reference signal resource (configured for channel measurement) based on the corresponding first resource parameter. Optionally, for a corresponding (or selected) resource set, refer to the above description for the methods for using the first resource parameter.

Optionally, the second sub-configuration includes/is associated with/corresponds to/indicates a first resource parameter and/or a first resource set indication parameter. Optionally, the information for the CSI report configuration corresponds to a plurality of resource sets (configured for channel measurement). Optionally, the second sub-configuration includes/is associated with/corresponds to/indicates a first resource set indication parameter. Optionally, the first resource set indication parameter indicates/selects one set of a plurality of resources sets (configured for channel measurement) corresponding to the information for the CSI report configuration. Optionally, the second sub-configuration includes/is associated with/indicates a first resource parameter. Optionally, the first resource parameter is configured to indicate a reference signal (configured for channel measurement) corresponding to the information for the CSI report configuration. Optionally, for a corresponding (or selected) resource set, refer to the above description for the methods for using the first resource parameter. For example, (the resource setting corresponding to) the information for the CSI report configuration includes three resource sets configured for channel measurement, which are {CSI-RS#1, CSI-RS#2, CSI-RS#3, CSI-RS#4}, {CSI-RS#5, CSI-RS#6}, and {CSI-RS#7, CSI-RS#8, CSI-RS#9, CSI-RS#10}, a first resource set indication parameter indicates {0}, and a first resource parameter indicates {CSI-RS#1, CSI-RS #4}. Herein, if the first resource set indication parameter indicates 0 (or, indicates a first state), a first resource set is indicated; if indicates 1 (or, a second state), a second resource set is indicated, and so on. Here, the first resource parameter may be used to indicate a resource (for example, a reference signal resource) in the resource set indicated by the first resource set indication parameter.

Optionally, the first CSI parameter corresponds to a resource configured for channel measurement for the second sub-configuration and/or a resource configured for interference measurement for the second sub-configuration. The first CSI parameter is described herein by taking CRI as an example. The CRI (or a CRI value) is represented by a parameter k. Optionally, k is a positive integer greater than or equal to 0 (k>=0). For example, different k values represent different reference signals configured for channel measurement and/or resources configured for interference measurement. Optionally, the corresponding (reported) CRI of the second sub-configuration corresponds to the resource configured for interference measurement for the second sub-configuration. Optionally, when the number of resources configured for interference measurement for the second sub-configuration is greater than 1, the CRI corresponding to the second sub-configuration is reported. Optionally, when the number of resources configured for interference measurement for the second sub-configuration is equal to 1, the value of the CRI corresponding to the second sub-configuration may be (or, may be regarded as) a specific value (for example, 0 or 1).

Optionally, the resource configured for interference measurement for the second sub-configuration includes/refers to a resource indicated by a second resource parameter included in/associated with the second sub-configuration and/or a resource indicated by a third resource parameter. Optionally, the second sub-configuration may include a second resource parameter and/or a third resource parameter. Optionally, the second resource parameter is configured to indicate one or more resources configured for interference measurement. Optionally, the second resource parameter may indicate one or more resources from the resource set (for example, CSI-IM-ResourceSet) that corresponds to/is associated with the information for the CSI report configuration. Optionally, the resource set corresponds to the information for the CSI report configuration. Optionally, a resource set is in a CSI resource setting corresponding to the information for the CSI report configuration. Optionally, the CSI resource setting is configured for interference measurement. For example, the CSI resource setting is associated with/corresponds to a CSI-IM resource parameter (for example, csi-IM-ResourcesForInterference) configured for interference measurement in the information for the CSI report configuration. For example, the CSI resource setting is CSI-ResourceConfig. Optionally, the third resource parameter is configured to indicate one or more resources configured for interference measurement. Optionally, the third resource parameter may indicate one or more resources from the resource set (for example, NZP-CSI-RS-ResourceSet) that corresponds to/is associated with the information for the CSI report configuration. Optionally, the resource set corresponds to the information for the CSI report configuration. Optionally, a resource set is in a CSI resource setting corresponding to the information for the CSI report configuration. Optionally, the CSI resource setting is configured for interference measurement. For example, the CSI resource setting is associated with/corresponds to an NZP CSI-RS resource parameter (for example, nzp-CSI-RS-ResourcesForInterference) configured for interference measurement in the NZP information for the CSI report configuration. For example, the CSI resource setting is CSI-ResourceConfig. The indication to a resource herein may be either an explicit indication or a direct indication. Optionally, the resource may be a reference signal resource. Optionally, the reference signal resource may be a reference signal. Optionally, the reference signal includes a CSI-RS or a CSI-IM. Optionally, the CSI-RS may be an NZP CSI-RS. As an example, the second resource parameter and the third resource parameter herein are two separate parameters, and the second resource parameter and the third resource parameter may also be a same parameter, which is not limited thereto in the disclosure.

Optionally, a mapping relationship between the second resource parameter and a resource indicated by it may be determined by one of the following methods:

### Method 1

The second resource parameter is a list. Optionally, one (or each) entry in the list indicates a resource ID (for example, a CSI-IM resource ID). Optionally, the resource corresponding to the resource ID belongs to a resource set configured for interference measurement and corresponding to the information for the CSI report configuration (for example, CSI-IM-ResourceSet). For example, if the resource set configured for interference measurement and corresponding to the information for the CSI report configuration is {CSI-IM #1, CSI-IM #3, CSI-IM #4, CSI-IM #7} and the second resource parameter indicates {#1, #7}, then the interference measurement resource corresponding to the second sub-configuration is {CSI-IM #1, CSI-IM #7}. A terminal device uses the resource corresponding to the resource ID indicated in the list to perform interference measurement (instead of using all resources in the resource set configured for interference measurement and corresponding to the information for the CSI report configuration).

### Method 2

The second resource parameter is a list. Optionally, one (or each) entry in the list indicates an index of a resource in a resource set. For example, a first resource in the resource set has an index 0, a second reference signal resource in the resource set has an index 1, and so on. Optionally, the resource set is/includes the resource set configured for interference measurement and corresponding to the information for the CSI report configuration (for example, CSI-IM-ResourceSet). For example, if the set configured for interference measurement and corresponding to the information for the CSI report configuration is {CSI-IM #1, CSI-IM #3, CSI-IM #4, CSI-IM #7} and the second resource parameter indicates {0, 2}, then the interference measurement resource corresponding to the second sub-configuration is {CSI-IM #1, CSI-IM #4}. A terminal device uses the resource indicated in the list to perform interference measurement (instead of using all resources in the resource set configured for interference measurement and corresponding to the information for the CSI report configuration).

The above methods may identify a mapping relationship between the second resource parameter and the corresponding resource, improving the reliability of the communication system.

Optionally, where the first CSI parameter corresponds to a resource configured for interference measurement for the second sub-configuration, it means that the first CSI parameter corresponds to a resource configured for interference measurement indicated by the second resource parameter for the second sub-configuration. As an example, where the first CSI parameter is a CRI, there is a mapping relationship between the CRI and the resource configured for interference measurement indicated by the second resource parameter. The mapping relationship may be determined by one of the following methods:

### Method 1

The CRI is determined based on an order/position of the resource configured for interference measurement indicated by the second resource parameter in the resource set configured for interference measurement and corresponding to the information for the CSI report configuration. Optionally, the k value corresponding to the CRI indicates the (k+1)th resource in the resource set configured for interference measurement and corresponding to the information for the CSI report configuration, as indicated by the second resource parameter. For example, if the resource set configured for interference measurement and corresponding to the information for the CSI report configuration is {CSI-IM #1, CSI-IM #3, CSI-IM #4, CSI-IM #7}, and the second resource parameter indicates CSI-IM #4 and CSI-IM #1, then k=0 corresponds to CSI-IM #1 and k=1 corresponds to CSI-IM #4.

### Method 2

The CRI is determined based on an order/position of the resource configured for interference measurement indicated by the second resource parameter in the second resource parameter. Optionally, the value k corresponding to the CRI represents the resource indicated by entry k+1 of the second resource parameter. For example, if the resource set configured for interference measurement and corresponding to the information for the CSI report configuration is {CSI-IM #1, CSI-IM #3, CSI-IM #4, CSI-IM #7}, and the second resource parameter indicates CSI-IM #4 and CSI-IM #1 (for example, the CSI-RS#4 corresponds to a first entry in the second resource parameter; the CSI-IM #1 corresponds to a second entry in the second resource parameter), then k=0 corresponds to CSI-IM #4 and k=1 corresponds to CSI-IM #1.

### Method 3

The CRI is determined based on an order (for example, a magnitude order) of the resource ID of the resource configured for interference measurement indicated by the second resource parameter. For example, the order is an ascending order or a descending order. Optionally, the value k corresponding to the CRI indicates the resource with the k+1st highest ID (or the k+1st lowest) ID among the resources indicated by the second resource parameter. As an example, where the value k corresponding to CRI indicates the resource with the k+1 lowest ID indicated by the second resource parameter, the resource set configured for interference measurement and corresponding to the information for the CSI report configuration is {CSI-IM #3, CSI-IM #1, CSI-IM #4, CSI-IM #7}, and the second resource parameter indicates {CSI-IM #3, CSI-IM #1, CSI-IM #4}, then k=0 corresponds to CSI-RS#1; k=1 corresponds to CSI-IM #3; and k=2 corresponds to CSI-IM #4.

The above methods may define the mapping relationship between the CRI (or k) and the corresponding resource, improving the reliability of the communication system. Based on the methods 1 to 3 above, one CRI value may be associated with one resource configured for channel measurement and at least one resource configured for interference resource. Different CRI values may be associated with different resource pairs, where each resource pair may include one resource configured for channel measurement and one resource configured for interference resource. Therefore, a terminal device performs channel measurement and interference measurement on resources in different resource pairs, selects at least one resource pair from them, and reports its corresponding information to a base station. Defining the mapping relationship between the resource indicated by the second resource parameter (and/or the resource indicated by the first resource parameter) and the CRI may avoid different understandings of the reported information between the terminal device and the base station.

Optionally, when a second condition is satisfied, the second sub-configuration includes/is associated with/corresponds to/indicates at least one of the following: a plurality of second resource parameters, or, a second resource parameter and/or a second resource set indication parameter. Optionally, the second condition includes at least one of the following:
The information for the CSI report configuration corresponds to a plurality of (aperiodic) resource sets. Optionally, the resource set may be configured for channel measurement and/or for interference measurement. Optionally, the resource setting configured for interference measurement and corresponding to (or associated with) the information for the CSI report configuration includes a plurality of (aperiodic) resource sets. For example, the CSI-ResourceConfig configured by the csi-IM-ResourcesForInterference parameter for CSI-ReportConfig includes a plurality of resource sets (for example, CSI-IM-ResourceSet).
The information for the CSI report configuration corresponds to an aperiodic resource set. Optionally, the resource set may be configured for channel measurement and/or for interference measurement. Optionally, the resource setting configured for channel measurement and corresponding to (or associated with) the information for the CSI report configuration includes an aperiodic resource set. For example, the CSI-ResourceConfig configured by the resourcesForChannelMeasurement parameter for CSI-ReportConfig includes a resource set (for example, NZP-CSI-RS-ResourceSet). For example, the resource type of the resource setting is aperiodic.
A UE is configured with a CSI aperiodic triggering state list parameter (CSI-AperiodicTriggerStateList).

Optionally, the second sub-configuration includes/is associated with/corresponds to/indicates a plurality of second resource parameters. Optionally, the information for the CSI report configuration corresponds to a plurality of resource sets (configured for interference measurement). Optionally, the number of the plurality of resource sets (configured for interference measurement) corresponding to the information for the CSI report configuration is equal to the number of the plurality of second resource parameters. Optionally, the plurality of resource sets configured for interference measurement and corresponding to the information for the CSI report configuration correspond to the plurality of second resource parameters in a one-to-one correspondence. Optionally, a one-to-one correspondence may be a one-to-one correspondence sequentially. Optionally, the order/position may be determined based on a (sequential) order/position of a plurality of resource sets configured for interference measurement in the resource setting and/or a (sequential) order/position of a plurality of first resource parameters in the corresponding list. For example, (the resource setting corresponding to) the information for the CSI report configuration includes three resource sets configured for interference measurement, which respectively are {CSI-IM #1, CSI-IM #2, CSI-IM #3, CSI-IM #4}, {CSI-IM #5, CSI-IM #6}, and {CSI-IM #7, CSI-IM #8, CSI-IM #9, CSI-IM #10}, and the three second resource parameters respectively indicate {CSI-IM #1, CSI-IM #4}, {CSI-IM #6}, and {CSI-IM #9, CSI-IM #10}. The three resource sets correspond to the three first resource parameters in a one-to-one correspondence sequentially. Optionally, refer to the above description for the methods for using (each of) the second resource parameters.

Optionally, (for a CSI report), (only) one of the plurality of (aperiodic) resource sets in the resource setting is associated with a triggering state. Optionally, each triggering state for each resource setting may be configured with a parameter for selecting a resource set in the resource setting. Optionally, the UE receives a triggering signaling (for example, a DCI format) for an aperiodic CSI report. Optionally, the triggering signaling may indicate a triggering state. The UE may determine one of the plurality of (aperiodic) resource sets in the resource setting based on the parameter associated with the triggering state (optionally, a parameter configured for the triggering state). Optionally, the selected/indicated (aperiodic) resource set determines a reference signal resource (configured for interference measurement) based on the corresponding second resource parameter. Optionally, for a corresponding (or selected) resource set, refer to the above description for the methods for using the second resource parameter.

Optionally, the second sub-configuration includes/is associated with/corresponds to/indicates a second resource parameter and/or a second resource set indication parameter. Optionally, the information for the CSI report configuration corresponds to a plurality of resource sets (configured for interference measurement). Optionally, the second sub-configuration includes/is associated with/corresponds to/indicates a second resource set indication parameter. Optionally, the second resource set indication parameter indicates/selects one set of a plurality of resources sets (configured for interference measurement) corresponding to the information for the CSI report configuration. Optionally, the second sub-configuration includes/is associated with/corresponds to/indicates a second resource parameter. Optionally, the second resource parameter is configured to indicate a reference signal (configured for interference measurement) corresponding to the information for the CSI report configuration. Optionally, for a corresponding (or selected) resource set, refer to the above description for the methods for using the second resource parameter. For example, (the resource setting corresponding to) the information for the CSI report configuration includes three resource sets configured for interference measurement, namely {CSI-IM #1, CSI-IM #2, CSI-IM #3, CSI-IM #4}, {CSI-IM #5, CSI-IM #6}, {CSI-IM #7, CSI-IM #8, CSI-IM #9, CSI-IM #10}, {CSI-IM #7, CSI-IM #8, CSI-IM #9, CSI-IM #10}, a second resource set parameter indicates {0}, and a second resource set parameter indicates {CSI-IM #1, CSI-IM #4}. Herein, if the second resource set indication parameter indicates 0 (or, indicates a first state), a first resource set is indicated; if indicates 1 (or, a second state), a second resource set is indicated, and so on. Here, the second resource parameter may be configured to indicate a resource (for example, a reference signal resource) in the resource set indicated by the second resource set indication parameter. Refer to the above description for the methods for using the second resource parameter.

Optionally, a mapping relationship between the third resource parameter and a resource indicated by it may be determined by one of the following methods:

### Method 1

The third resource parameter is a list. Optionally, one (or each) entry in the list indicates a resource ID (for example, a CSI-RS resource ID). Optionally, the resource corresponding to the resource ID belongs to a resource set configured for interference measurement and corresponding to the information for the CSI report configuration (for example, NZP-CSI-RS-ResourceSet). For example, if the resource set configured for interference measurement and corresponding to the information for the CSI report configuration is {CSI-RS#1, CSI-RS#3, CSI-RS#4, CSI-RS#7} and the third resource parameter indicates {#1, #7}, the interference measurement resource corresponding to the second sub-configuration is {CSI-RS#1, CSI-RS#7}. A terminal device uses the reference signal resource corresponding to the resource ID indicated in the list to perform interference measurement (instead of using all reference signal resources in the resource set configured for interference measurement and corresponding to the information for the CSI report configuration).

### Method 2

The third resource parameter is a list. Optionally, one (or each) entry in the list indicates an index of a resource in a resource set. For example, a first resource in the resource set has an index 0, a second resource in the resource set has an index 1, and so on. Optionally, the resource set is/includes the resource set configured for interference measurement and corresponding to the information for the CSI report configuration (for example, NZP-CSI-RS-ResourceSet). For example, if the resource set configured for interference measurement and corresponding to the information for the CSI report configuration is {CSI-RS#1, CSI-RS#3, CSI-RS#4, CSI-RS#7} and the third resource parameter indicates {0, 2}, the interference measurement reference signal resource corresponding to the second sub-configuration is {CSI-RS #1, CSI-RS#4}. A terminal device uses the resource indicated in the list to perform interference measurement (instead of using all resources in the resource set configured for interference measurement and corresponding to the information for the CSI report configuration).

The above methods may identify a mapping relationship between the third resource parameter and the corresponding resource, improving the reliability of the communication system.

Optionally, where the first CSI parameter corresponds to a resource configured for interference measurement for the second sub-configuration, it means that the first CSI parameter corresponds to a resource (for example, a reference signal resource) configured for interference measurement indicated by the first resource parameter for the second sub-configuration. As an example, where the first CSI parameter is a CRI, there is a mapping relationship between the CRI and the resource configured for interference measurement indicated by the third resource parameter. The mapping relationship may be determined by at least one of the following methods:

### Method 1

The CRI is determined based on an order/position of the resource configured for interference measurement indicated by the third resource parameter in the resource set configured for interference measurement and corresponding to the information for the CSI report configuration. Optionally, the k value corresponding to the CRI indicates the k+1st resource in the resource set configured for interference measurement and corresponding to the information for the CSI report configuration, as indicated by the third resource parameter. For example, if the resource set configured for interference measurement and corresponding to the information for the CSI report configuration is {CSI-RS#1, CSI-RS#3, CSI-RS#4, CSI-RS#7}, and the third resource parameter indicates CSI-RS#4 and CSI-RS#1, then k=0 corresponds to CSI-RS#1 and k=1 corresponds to CSI-RS#4.

### Method 2

The CRI is determined based on an order/position of the resource configured for interference measurement indicated by the third resource parameter in the third resource parameter. Optionally, the value k corresponding to the CRI represents the resource indicated by entry k+1 of the third resource parameter. For example, if the resource set configured for interference measurement and corresponding to the information for the CSI report configuration is {CSI-RS#1, CSI-RS#3, CSI-RS#4, CSI-RS#7}, and the third resource parameter indicates CSI-RS#4 and CSI-RS#1 (for example, CSI-RS#4 corresponds to the first entry of the third resource parameter; CSI-RS#1 corresponds to the second entry of the third resource parameter), then k=0 corresponds to CSI-RS#4 and k=1 corresponds to CSI-RS#1.

### Method 3

The CRI is determined based on an order/position (for example, a magnitude order/position) of the resource ID of the resource configured for interference measurement indicated by the third resource parameter. For example, the order is an ascending order or a descending order. Optionally, the value k corresponding to the CRI indicates the resource with the k+1st highest ID (or the k+1st lowest) ID among the resources indicated by the third resource parameter. As an example, where the value k corresponding to CRI indicates the resource with the k+1 lowest ID indicated by the third resource parameter, the resource set configured for interference measurement and corresponding to the information for the CSI report configuration is {CSI-RS#3, CSI-RS#1, CSI-RS#4, CSI-RS#7}, and the third resource parameter indicates {CSI-RS #3, CSI-RS#1, CSI-RS#4}, then k=0 corresponds to CSI-RS#1; k=1 corresponds to CSI-RS#3; and k=2 corresponds to CSI-RS#4.

The above methods may identify the mapping relationship between the CRI (or k) and the corresponding resource, improving the reliability of the communication system. Based on the methods above, one CRI value may be associated with one resource configured for channel measurement and at least one resource configured for interference resource. Different CRI values may be associated with different resource pairs, where each resource pair may include one resource configured for channel measurement and one resource configured for interference resource. Therefore, a terminal device performs channel measurement and interference measurement on resources in different resource pairs, selects at least one resource pair from them, and reports its corresponding information to a base station. Defining the mapping relationship between the resource indicated by the third resource parameter (and/or the resource indicated by the first resource parameter and/or the resource indicated by the second resource parameter) and the CRI may avoid different understandings of the reported information between the terminal device and the base station.

Optionally, when a second condition is satisfied, the second sub-configuration includes/is associated with/corresponds to/indicates at least one of the following: a plurality of third resource parameters, or, a third resource parameter and/or a third resource set indication parameter. Optionally, the second condition includes at least one of the following:
The information for the CSI report configuration corresponds to a plurality of (aperiodic) resource sets. Optionally, the resource set may be configured for channel measurement and/or for interference measurement. Optionally, the resource setting configured for interference measurement and corresponding to (or associated with) the information for the CSI report configuration includes a plurality of (aperiodic) resource sets. For example, the CSI-ResourceConfig configured by the nzp-CSI-RS-ResourcesForInterference parameter for CSI-ReportConfig includes a plurality of resource sets (for example, NZP-CSI-RS-ResourceSet).
The information for the CSI report configuration corresponds to an aperiodic resource set. Optionally, the resource set may be configured for channel measurement and/or for interference measurement. Optionally, the resource setting configured for channel measurement and corresponding to (or associated with) the information for the CSI report configuration includes an aperiodic resource set. For example, the CSI-ResourceConfig configured by the resourcesForChannelMeasurement parameter for CSI-ReportConfig includes a resource set (for example, NZP-CSI-RS-ResourceSet). For example, the resource type of the resource setting is aperiodic.
A UE is configured with a CSI aperiodic triggering state list parameter (CSI-Aperiodic TriggerStateList).

Optionally, the second sub-configuration includes/is associated with/corresponds to/indicates a plurality of third resource parameters. Optionally, the information for the CSI report configuration corresponds to a plurality of resource sets (configured for interference measurement). Optionally, the number of the plurality of resource sets (configured for interference measurement) corresponding to the information for the CSI report configuration is equal to the number of the plurality of third resource parameters. Optionally, the plurality of resource sets configured for interference measurement and corresponding to the information for the CSI report configuration correspond to the plurality of third resource parameters in a one-to-one correspondence. Optionally, a one-to-one correspondence may be a one-to-one correspondence sequentially. Optionally, the order/position may be determined based on a (sequential) order/position of a plurality of resource sets configured for interference measurement in the resource setting and/or a (sequential) order/position of a plurality of third resource parameters in the corresponding list. For example, (the resource setting corresponding to) the information for the CSI report configuration includes three resource sets configured for interference measurement, which respectively are {CSI-RS#1, CSI-RS#2, CSI-RS#3, CSI-RS#4}, {CSI-RS#5, CSI-RS#6}, and {CSI-RS#7, CSI-RS#8, CSI-RS#9, CSI-RS#10}, the three third resource parameters indicate {CSI-RS#1, CSI-RS#4}, {CSI-RS#6}, and {CSI-RS#9, CSI-RS#10}. The three resource sets correspond to the three third resource parameters in a one-to-one correspondence sequentially. Optionally, refer to the above description for the methods for using (each of) the third resource parameters.

Optionally, (for a CSI report), (only) one of the plurality of (aperiodic) resource sets in the resource setting is associated with a triggering state. Optionally, each triggering state for each resource setting may be configured with a parameter for selecting a resource set in the resource setting. Optionally, the UE receives a triggering signaling (for example, a DCI format) for an aperiodic CSI report. Optionally, the triggering signaling may indicate a triggering state. The UE may determine one of the plurality of (aperiodic) resource sets in the resource setting based on the parameter associated with the triggering state (optionally, a parameter configured for the triggering state). Optionally, the selected/indicated (aperiodic) resource set determines a reference signal resource (configured for interference measurement) based on the corresponding first resource parameter. Optionally, for a corresponding (or selected) resource set, refer to the above description for the methods for using the third resource parameter.

Optionally, the second sub-configuration includes/is associated with/corresponds to/indicates a third resource parameter and/or a third resource set indication parameter. Optionally, the information for the CSI report configuration corresponds to a plurality of resource sets (configured for interference measurement). Optionally, the second sub-configuration includes/is associated with/corresponds to/indicates a third resource set indication parameter. Optionally, the third resource set indication parameter indicates/selects one set of a plurality of resources sets (configured for interference measurement) corresponding to the information for the CSI report configuration. Optionally, the second sub-configuration includes/is associated with/corresponds to/indicates a third resource parameter. Optionally, the third resource parameter is configured to indicate a reference signal (configured for channel measurement) corresponding to the information for the CSI report configuration. Optionally, for a corresponding (or selected) resource set, refer to the above description for the methods for using the third resource parameter. For example, (the resource setting corresponding to) the information for the CSI report configuration includes three resource sets configured for interference measurement, which respectively are {CSI-RS #1, CSI-RS#2, CSI-RS#3, CSI-RS#4}, {CSI-RS#5, CSI-RS#6}, and {CSI-RS #7, CSI-RS#8, CSI-RS#9, CSI-RS#10}, a third resource set indication parameter indicates {0}, and a third resource parameter indicates {CSI-RS#1, CSI-RS#4}. Herein, if the third resource set indication parameter indicates 0 (or, indicates a first state), a first resource set is indicated; if indicates 1 (or, a second state), a second resource set is indicated, and so on. Here, the third resource parameter may be configured to indicate a resource (for example, a reference signal resource) in the resource set indicated by the third resource set indication parameter. Refer to the above description for the methods for using the third resource parameter.

Optionally, the second sub-configuration includes (one or more) first resource parameters, and the second sub-configuration includes (one or more) second resource parameters and/or (one or more) third resource parameters. The following provides a method for mapping a channel measurement resource to an interference measurement resource, so that a terminal device may use a correct resource combination for measurement and CSI parameter computation, which improves the reliability of a communication system. Optionally, a resource indicated by a first resource parameter and a resource indicated by a second resource parameter are associated based on at least one of the following:
An order/position of resources indicated by the first resource parameter. For example, an order/position of resources indicated by the first resource parameter in the indication parameter. For example, an order/position of resources indicated by the first resource parameter in a resource set corresponding to the information for the CSI report configuration. For example, an order (an ascending order or a descending order) of resource IDs indicated by the first resource parameter.
An order/position of resources indicated by the second resource parameter. For example, an order/position of resources indicated by the second resource parameter in the indication parameter. For example, an order/position of resources indicated by the second resource parameter in a resource set corresponding to the information for the CSI report configuration. For example, an order (an ascending order or a descending order) of resource IDs indicated by the second resource parameter.

Optionally, a resource indicated by a first resource parameter and a resource indicated by a third resource parameter are associated based on at least one of the following:
An order/position of resources indicated by the first resource parameter. For example, an order/position of resources indicated by the first resource parameter in the indication parameter. For example, an order/position of resources indicated by the first resource parameter in a resource set corresponding to the information for the CSI report configuration. For example, an order (an ascending order or an descending order) of resource IDs indicated by the first resource parameter.
An order/position of resources indicated by the third resource parameter. For example, an order/position of resources indicated by the third resource parameter in the indication parameter. For example, an order/position of resources indicated by the third resource parameter in a resource set corresponding to the information for the CSI report configuration. For example, an order (an ascending order or a descending order) of resource IDs indicated by the third resource parameter.

For example, (the resource setting corresponding to) the information for the CSI report configuration includes a resource set configured for channel measurement, namely {CSI-RS#1, CSI-RS#2, CSI-RS#3, CSI-RS#4}, and the first resource parameter indicates {CSI-RS#1, CSI-RS#4}; (the resource setting corresponding to) the information for the CSI report configuration includes a resource set configured for interference measurement, namely {CSI-IM #1, CSI-IM #2, CSI-IM #3, CSI-IM #4}, and the second resource parameter indicates {CSI-IM #1, CSI-IM #4}. Here, based on the order/position of the resources indicated by the first resource parameter in the first resource parameter, CSI-RS#1 is associated with CSI-IM #1 and CSI-RS#4 is associated with CSI-IM #4; and CSI-RS#4 is associated with CSI-IM #4.

Optionally, the number of the first resource parameters is equal to the number of the second resource parameters or the third resource parameters. Optionally, if the second sub-configuration includes (one or more) first resource parameters, and the second sub-configuration includes (one or more) second resource parameters and/or (one or more) third resource parameters, the number of the first resource parameters is equal to the number of the second resource parameters or the third resource parameters. Optionally, the first resource parameter, the second resource parameter, or the third resource parameter corresponds to each other in a one-to-one correspondence. Optionally, if the second sub-configuration includes (one or more) first resource parameters, and the second sub-configuration includes (one or more) second resource parameters and/or (one or more) third resource parameters, the (one or more) first resource parameters, the (one or more) second resource parameters, or the (one or more) third resource parameters correspond to each other in a one-to-one correspondence. Optionally, if the second sub-configuration includes (one or more) first resource parameters, and the second sub-configuration includes (one or more) second resource parameters and/or (one or more) third resource parameters, the resources indicated by the first resource parameter correspond to the resources (associated with) the second resource parameter or the third resource parameter in a one-to-one correspondence.

For example, (the resource setting corresponding to) the information for the CSI report configuration includes three resource sets configured for channel measurement, namely {CSI-RS#1, CSI-RS#2, CSI-RS#3, CSI-RS#4}, {CSI-RS#5, CSI-RS#6}, and {CSI-RS#7, CSI-RS#8, CSI-RS#9, CSI-RS#10}, the three first resource parameters respectively indicate {CSI-RS#1, CSI-RS#4}, {CSI-RS#6}, {CSI-RS#9, CSI-RS#10}; (the resource setting corresponding to) the information for the CSI report configuration includes three resource sets configured for interference measurement, namely {CSI-IM #1, CSI-IM #2, CSI-IM #3, CSI-IM #4}, {CSI-IM #5, CSI-IM #6}, {CSI-IM #7, CSI-IM #8, CSI-IM #9, CSI-IM #10}, the three second resource parameters respectively indicate {CSI-IM #1, CSI-IM #4}, {CSI-IM #6}, and {CSI-IM #9, CSI-IM #10}. Here, the number of resource sets configured for channel measurement is equal to the number of resource sets configured for interference measurement. Here, the number of a plurality of resource sets configured for channel measurement is equal to the number of a plurality of resource sets configured for interference measurement. Here, the number of resources in a resource set configured for channel measurement is equal to the number of resources in a resource set configured for interference measurement. Optionally, the resources in a resource set configured for channel measurement is associated with (or in a one-to-one correspondence with) the resources in a resource set configured for interference measurement based on an order/position of the resources.

Optionally, if the first CSI parameter corresponding to the resource configured for the channel measurement for the second sub-configuration is the same as the first CSI parameter corresponding to the resource configured for the interference measurement for the second sub-configuration (for example, the values of the first CSI parameters are the same, or the CRI values are the same), then the resource configured for channel measurement is associated with the resource configured for interference measurement. For example, where the resource configured for channel measurement is associated with the resource configured for interference measurement, it means that a CQI corresponding to the first CSI parameter (for example, a CRI) is computed based on (a measurement result of) the resource configured for channel measurement and the resource configured for channel measurement.

The following describes a quasi co-location relationship between a channel measurement resource and an interference measurement resource, so that a terminal device may use a correct spatial parameter to measure a corresponding resource combination and compute the CSI parameter, which improves the reliability of a communication system. Optionally, the resource configured for channel measurement and the resource configured for interference measurement are quasi-colocated (for example, type D quasi-colocated). Optionally, the resource configured for channel measurement and the associated resource configured for interference measurement are quasi-colocated (for example, type D quasi-colocated). Optionally, the resource configured for channel measurement and the resource configured for interference measurement are quasi-colocated resource-wise (for example, type D quasi-colocated). Optionally, the resource configured for channel measurement (for example, an NZP CSI-RS resource) and the resource configured for interference measurement (for example, an NZP CSI-RS resource or a CSI-IM resource) are quasi-colocated (for example, type D quasi-colocated). Optionally, a UE may assume that the associated resource configured for channel measurement and the resource configured for interference measurement are quasi-colocated (for example, type D quasi-colocated). Optionally, a UE may assume that the associated resource configured for channel measurement (for example, an NZP CSI-RS resource) and the resource configured for interference measurement (for example, an NZP CSI-RS resource or a CSI-IM resource) are quasi-colocated (for example, type D quasi-colocated).

For example, (the resource setting corresponding to) the information for the CSI report configuration includes a resource set configured for channel measurement, namely {CSI-RS#1, CSI-RS#2, CSI-RS#3, CSI-RS#4}, a first resource parameter indicates {CSI-RS#1, CSI-RS#4}, and a mapping relationship between a CRI and a resource configured for channel measurement is based on an order/position of resources in a resource set configured for channel measurement in the information for the CSI report configuration; additionally, (the resource setting corresponding to) the information for the CSI report configuration includes a resource set configured for interference measurement, namely {CSI-IM #1, CSI-IM #2, CSI-IM #3, CSI-IM #4}, a second resource parameter indicates {CSI-IM #1, CSI-IM #3}, and a mapping relationship between a CRI and a resource configured for interference measurement is based on an order/position of resources in a resource set configured for interference measurement in the information for the CSI report configuration. In this case, the CRI may be either 0 or 1. When the CRI is equal to 0, the resource configured for channel measurement and corresponding to the CRI is CSI-RS#1; and the resource configured for interference measurement and corresponding to the CRI is CSI-IM #1. When the CRI is equal to 1, the resource configured for channel measurement and corresponding to the CRI is CSI-RS#4; and the resource configured for interference measurement and corresponding to the CRI is CSI-IM #3. The CSI-RS#1 and CSI-IM #1 are about type D quasi co-location, or a UE may assume that the CSI-RS#1 and the CSI-IM #1 are about type D quasi co-location. The CSI-RS#4 and CSI-IM #3 are about type D quasi co-location, or a UE may assume that the CSI-RS#4 and the CSI-IM #3 are about type D quasi co-location.

Here, by indicating through an explicit parameter a resource configured for channel measurement and/or a resource configured for interference measurement of a sub-configuration (for example, by indicating a resource configured for channel measurement and/or a resource configured for interference measurement through at least one of a first resource parameter, a second resource parameter, and a third resource parameter), a terminal device may correctly use a corresponding resource to correctly compute the CSI parameters of the sub-configuration, improving the reliability of a communication system.

In addition, the following continues to describes the method for determining a resource configured for interference measurement of a sub-configuration in an explicit way (for example, determining a resource configured for channel measurement and/or a resource configured for interference measurement based on a first resource parameter), so that a terminal device may correctly use a corresponding resource to correctly compute the CSI parameters of the sub-configuration, improving the reliability of a communication system.

Optionally, the number of resources in a resource set configured for interference measurement and corresponding to the information for the CSI report configuration is associated with the number of resources configured for channel measurement in one or more first sub-configurations; and/or
the order/position of resources in a resource set configured for interference measurement and corresponding to the information for the CSI report configuration is associated with the order/position of one or more first sub-configurations.

Optionally, the information for the CSI report configuration is associated with/corresponds to/includes a resource set configured for interference measurement (for example, CSI-IM-ResourceSetor NZP-CSI-RS-ResourceSet). Optionally, the resource set includes one or more resources. Optionally, the resource may be an NZP CSI-RS resource. Optionally, the resource may be a CSI-IM resource. Optionally, a resource set is in a CSI resource setting corresponding to the information for the CSI report configuration. Optionally, the CSI resource setting is configured for interference measurement. For example, the CSI resource setting is associated with/corresponds to a CSI-IM resource parameter (for example, csi-IM-ResourcesForInterference) configured for interference measurement in the information for the CSI report configuration. For example, the CSI resource setting is associated with/corresponds to an NZP CSI-RS resource parameter (for example, nzp-CSI-RS-ResourcesForInterference) configured for interference measurement in the information for the CSI report configuration. For example, the CSI resource setting is CSI-ResourceConfig.

Optionally, when a second condition is satisfied, the information for the CSI report configuration may be associated with/correspond to a plurality of resource sets (configured for interference measurement). Here, refer to the above description for the second condition. Optionally, the second sub-configuration may include or be associated with one resource set in a plurality of resource sets indicated by a second resource set indication parameter and/or a third resource set indication parameter. Optionally, (for a CSI report), (only) one of the plurality of (aperiodic) resource sets is associated with a triggering state. Optionally, each triggering state for each resource setting may be configured with a parameter for selecting a resource set in the resource setting. Optionally, the UE receives a triggering signaling (for example, a DCI format) for an aperiodic CSI report. Optionally, the triggering signaling may indicate a triggering state. The UE may determine one resource set of the plurality of (aperiodic) resource sets in the resource setting based on the parameter associated with the triggering state (optionally, a parameter configured for the triggering state).

The characteristics of the resource set (configured for interference measurement) corresponding to/included in/configured for the information for the CSI report configuration are described further below. For example, the characteristics of the resource sets (configured for interference measurement) selected/determined by the above methods.

Optionally, the number of resources in a resource set configured for interference measurement and corresponding to the information for the CSI report configuration is based on the number of resources configured for channel measurement in one or more first sub-configurations. Optionally, the number of resources in a resource set configured for interference measurement and corresponding to the information for the CSI report configuration is equal to the number of resources configured for channel measurement in one or more first sub-configurations. Optionally, (each of) the one or more first sub-configurations have resources configured for channel measurement. Here, see the description above for the methods for determining the resources configured for channel measurement in the first sub-configuration (for example, indicated by the first resource parameter). For a sub-configuration #i, the number of resources configured for channel measurement is Ki. Here, 1≤i≤L. For example, a sub-configuration #1 has K1 resources configured for channel measurement, a sub-configuration #2 has K2 resources configured for channel measurement, and so on. The number of resources in a resource set configured for interference measurement and corresponding to the information for the CSI report configuration is the sum of the number of resources configured for channel measurement in all first sub-configurations. For example, the number of resources in a resource set configured for interference measurement and corresponding to the information for the CSI report configuration is

$${\sum }_{i = 1}^{L} {K}_{i}^{\cdot }$$

Optionally, the order/position of resources in a resource set configured for interference measurement and corresponding to the information for the CSI report configuration is based on the order/position of resources and the order/position of first sub-configurations. Optionally, the order/position of resources may be a sequential order/position of the resources in a resource set (for example, a sequential order/position of the resources in the configuration information). For example, in the resource set, the first K1 resources are resources configured for interference measurement in a sub-configuration #1, the next K2 resources (for example, resource K1+1 to resource K1+K2) are resources configured for interference measurement in a sub-configuration #2, the next K3 resources (for example, resource K1+K2+1 to resource K1+K2+K3) are resources configured for interference measurement in a sub-configuration #3, and so on. Optionally, the order/position of resources may be a sequential order/position of the resources in a resource set (for example, a sequential order/position of the resources in the configuration information). Optionally, the order of resources may be an order of Ids (for example, a sequential order of resources). For example, the order is a descending order or an ascending order. For example, in the resource set, the K1 resources having the lowest IDs are resources configured for interference measurement in a sub-configuration #1, the K2 resources having the next lowest IDs (for example, the resource having the K1+1 lowest ID to the resource having the K1+K2 lowest ID) are resources configured for interference measurement in a sub-configuration #2, and so on.

Optionally, the order of one or more first sub-configurations may be an order of IDs of the one or more first sub-configurations. For example, an ascending order or a descending order of IDs of the first sub-configurations. Optionally, a first sub-configuration may configured with an ID. Optionally, each of the first sub-configurations may be configured with an ID (for example, a sub-configuration ID). For example, a sub-configuration #1, a sub-configuration #2, . . . , a sub-configuration #L correspond to L sub-configurations having IDs arranged in an ascending/descending order of the information for the CSI report configuration (or of a CSI report). Optionally, the order/position of the first sub-configurations may be the order/position of the sub-configurations in the configuration information. For example, the sequential order/position of the first sub-configurations in the information for the CSI report configuration. For example, a sub-configuration #1, a sub-configuration #2, . . . , a sub-configuration #L correspond to L sub-configurations arranged in a sequential order of the sub-configurations (in the configuration information) of the information for the CSI report configuration (or of a CSI report).

Optionally, the resources configured for interference measurement for the second sub-configuration are selected/determined from a resource set configured for interference measurement and corresponding to the information for the CSI report configuration. Optionally, the resources configured for interference measurement for the second sub-configuration are from a resource set configured for interference measurement and corresponding to the information for the CSI report configuration. Optionally, the resources configured for interference measurement for the second sub-configuration include/refer to the resources associated with the second sub-configuration in the resource set configured for interference measurement and corresponding to the information for the CSI report configuration. For example, if the second sub-configuration is a sub-configuration #j, and j=1 (that is, a sub-configuration #1), the resources configured for interference measurement for the second sub-configuration are the first K1 resources. For example, if the second sub-configuration is a sub-configuration #j, and j>1, the resources configured for interference measurement for the second sub-configuration are Kj resources. Optionally, the resources configured for interference measurement for the second sub-configuration are resource

$${\sum }_{i = 1 = 0}^{j - 1} {K}_{i}^{+ 1 st}$$

to resource

$${\sum }_{i = 1}^{j} {K}_{i}$$

in the resource set. Optionally, the resources configured for interference measurement for the second sub-configuration are resource

$${\sum }_{i = 1}^{j - 1} {K}_{i}^{+ 1 st}$$

to resource

$${\sum }_{i = 1}^{j} {K}_{i}$$

in the resource set that are arranged by IDs sequentially (in an ascending order or a descending order). Here, Kᵢ refers to the number of resources configured for interference measurement and corresponding to a sub-configuration #i.

Optionally, the second sub-configuration includes/is associated with/corresponds to (one or more) first resource parameters. Optionally, a resource (configured for channel measurement) indicated by a first resource parameter and a resource configured for interference measurement in a second sub-configuration are associated based on at least one of the following:
An order/position of resources indicated by the first resource parameter. For example, an order/position of resources indicated by the first resource parameter in the first resource parameter. For example, an order/position of resources indicated by the first resource parameter in a resource set corresponding to the information for the CSI report configuration. For example, an order (an ascending order or a descending order) of resource IDs indicated by the first resource parameter.
The order/position of resources configured for interference measurement for the second sub-configuration. For example, the order/position of resources configured for interference measurement for the second sub-configuration in a resource set configured for interference measurement and corresponding to the information for the CSI report configuration. For example, an order (for example, an ascending order or a descending order) of resource IDs of resources configured for interference measurement for the second sub-configuration.

Optionally, the resource configured for channel measurement and the resource configured for interference measurement are quasi-colocated (for example, type D quasi-colocated). Optionally, the resource configured for channel measurement and the (associated) resource configured for interference measurement are quasi-colocated (for example, type D quasi-colocated). Optionally, a UE may assume that the associated resource configured for channel measurement and the resource configured for interference measurement are quasi-colocated (for example, type D quasi-colocated).

For example, a resource set configured for channel measurement and corresponding to the information for the CSI report configuration is {CSI-RS#1, CSI-RS#2, CSI-RS #3, CSI-RS#4}, and the resources indicated by the first resource parameter are {CSI-RS#1, CSI-RS#3}; a resource set configured for interference measurement and corresponding to the information for the CSI report configuration is {CSI-IM #1, CSI-IM #2, CSI-IM #3, CSI-IM #4}, and the resources configured for interference measurement for the second sub-configuration are {CSI-IM #1, CSI-IM #3}. Here, CSI-RS #1 is associated with CSI-IM #1. Here, CSI-RS#3 is associated with CSI-IM #3. Here, a UE may assume that CSI-RS#1 is type D quasi-colocated with CSI-IM #1. Here, a UE may assume that CSI-RS#3 is type D quasi-colocated with CSI-IM #3.

Optionally, where the first CSI parameter corresponds to a resource configured for interference measurement for the second sub-configuration, it means that the first CSI parameter corresponds to a resource configured for interference measurement for the second sub-configuration (for example, the resource configured for interference measurement as determined using the methods above). As an example, where the first CSI parameter is a CRI, there is a mapping relationship between the CRI and the resource configured for interference measurement for the second sub-configuration. The mapping relationship may be determined by at least one of the following methods:

### Method 1

The CRI is determined based on an order/position of the resource configured for interference measurement of the sub-configuration in the resource set configured for interference measurement and corresponding to the information for the CSI report configuration. Optionally, the k value corresponding to the CRI indicates the k+1st resource associated with the second sub-configuration in the resource set configured for interference measurement and corresponding to the information for the CSI report configuration. For example, if the resource set configured for interference measurement and corresponding to the information for the CSI report configuration is {CSI-RS#1, CSI-RS#3, CSI-RS#4, CSI-RS#7}, the resource configured for interference measurement of the second sub-configuration are CSI-RS#1 and CSI-RS #4, then k=0 corresponds to CSI-RS#1 and k=1 corresponds to CSI-RS#4.

### Method 2

The CRI is determined based on an order (for example, a magnitude order) of the IDs of the resources configured for interference measurement of the second sub-configuration. For example, the order is an ascending order or a descending order. Optionally, the value k corresponding to the CRI indicates the resource with the k+1st highest ID (or the k+1st lowest) ID among the resources configured for interference measurement of the second sub-configuration. As an example, where the value k corresponding to CRI indicates the resource with the k+1 lowest ID among the resources configured for interference measurement of the second sub-configuration, the resource set configured for interference measurement and corresponding to the information for the CSI report configuration is {CSI-RS#3, CSI-RS#1, CSI-RS#4, CSI-RS#7}, and the resources configured for interference measurement of the second sub-configuration are {CSI-RS#3, CSI-RS#1, CSI-RS#4}, then k=0 corresponds to CSI-RS#1; k=1 corresponds to CSI-RS#3; and k=2 corresponds to CSI-RS#4.

The above methods may identify the mapping relationship between the CRI (or k) and the corresponding resource, improving the reliability of the communication system.

Optionally, the resources configured for interference measurement for the second sub-configuration are determined based on resources configured for channel measurement of the second sub-configuration.

Optionally, the information for the CSI report configuration is associated with/corresponds to/includes a resource set configured for interference measurement (for example, CSI-IM-ResourceSet or NZP-CSI-RS-ResourceSet). Optionally, the resource set includes one or more resources. Optionally, the resource may be an NZP CSI-RS resource. Optionally, the resource may be a CSI-IM resource. Optionally, a resource set is in a CSI resource setting corresponding to the information for the CSI report configuration. Optionally, the CSI resource setting is configured for interference measurement. For example, the CSI resource setting is associated with/corresponds to a CSI-IM resource parameter (for example, csi-IM-ResourcesForInterference) configured for interference measurement in the information for the CSI report configuration. For example, the CSI resource setting is associated with/corresponds to an NZP CSI-RS resource parameter (for example, nzp-CSI-RS-ResourcesForInterference) configured for interference measurement in the information for the CSI report configuration. For example, the CSI resource setting is CSI-ResourceConfig.

Optionally, when a second condition is satisfied, the information for the CSI report configuration may be associated with/correspond to a plurality of resource sets (configured for interference measurement). Here, refer to the above description for the second condition. Optionally, the second sub-configuration may include or be associated with one resource set in a plurality of resource sets indicated by a second resource set indication parameter and/or a third resource set indication parameter. Optionally, (for a CSI report), (only) one of the plurality of (aperiodic) resource sets is associated with a triggering state. Optionally, each triggering state for each resource setting may be configured with a parameter for selecting a resource set in the resource setting. Optionally, the UE receives a triggering signaling (for example, DCI format) for an aperiodic CSI report. Optionally, the triggering signaling may indicate a triggering state. The UE may determine one resource set of the plurality of (aperiodic) resource sets in the resource setting based on the parameter associated with the triggering state (optionally, a parameter configured for the triggering state).

The characteristics of the resource set (configured for interference measurement) corresponding to/included in/configured for the information for the CSI report configuration are described further below. For example, the characteristics of the resource sets (configured for interference measurement) selected/determined by the above methods.

Optionally, the second sub-configuration includes/is associated with/corresponds to (one or more) first resource parameters. Optionally, the resource configured for channel measurement for the second sub-configuration may be indicated by the first resource parameter. See the above description for specific methods for indication (for example, a description of the first resource parameter). Optionally, the resources configured for interference measurement for the second sub-configuration are determined based on resources configured for channel measurement of the second sub-configuration. Optionally, the resources configured for interference measurement for the second sub-configuration are determined based on an order/position of the resources configured for channel measurement of the second sub-configuration in the resource set configured for channel measurement and corresponding to the information for the CSI report configuration. Optionally, the order/position of the resources configured for interference measurement for the second sub-configuration in the resource set configured for interference measurement and corresponding to the information for the CSI report configuration is the same as the order/position of the resources configured for channel measurement of the second sub-configuration in the resource set configured for interference measurement and corresponding to the information for the CSI report configuration. Optionally, a resource configured for interference measurement for the second sub-configuration is a resource at a first position in the resource set configured for interference measurement and corresponding to the CSI report configuration, where the first position is the same as the position of the resource configured for channel measurement of the second sub-configuration in the resource set configured for channel measurement and corresponding to the CSI report configuration. Optionally, a resource configured for channel measurement of the second sub-configuration (for example, a resource indicated by the first resource parameter) and a resource configured for interference measurement for the second sub-configuration are associated based on at least one of the following:
An order/position of resources indicated by the first resource parameter. For example, an order/position of resources indicated by the first resource parameter in the first resource parameter. For example, an order/position of resources indicated by the first resource parameter in a resource set corresponding to the information for the CSI report configuration. For example, an order (an ascending order or a descending order) of resource IDs indicated by the first resource parameter.
The order/position of resources configured for interference measurement for the second sub-configuration. For example, the order/position of resources configured for interference measurement for the second sub-configuration in a resource set configured for interference measurement and corresponding to the information for the CSI report configuration. For example, an order (for example, an ascending order or a descending order) of resource IDs of resources configured for interference measurement for the second sub-configuration.

Optionally, the resource configured for channel measurement and the resource configured for interference measurement are quasi-colocated (for example, type D quasi-colocated). Optionally, the resource configured for channel measurement and the (associated) resource configured for interference measurement are quasi-colocated (for example, type D quasi-colocated). Optionally, a UE may assume that the associated resource configured for channel measurement and the resource configured for interference measurement are quasi-colocated (for example, type D quasi-colocated).

For example, a resource set configured for channel measurement and corresponding to the information for the CSI report configuration is {CSI-RS#1, CSI-RS#2, CSI-RS #3, CSI-RS#4}, and the resources indicated by the first resource parameter are {CSI-RS#1, CSI-RS#3}, the corresponding position indexes are 1 and 3; a resource set configured for interference measurement and corresponding to the information for the CSI report configuration is {CSI-IM #1, CSI-IM #2, CSI-IM #3, CSI-IM #4}. Here, the same position indexes 1 and 3 may be used to determine the resources configured for interference measurement for the second sub-configuration, that is, {CSI-IM #1, CSI-IM #3}. Here, CSI-RS#1 is associated with CSI-IM #1 and CSI-RS#3 is associated with CSI-IM #3. Here, a UE may assume that CSI-RS#1 is type D quasi-colocated with CSI-IM #1. Here, a UE may assume that CSI-RS#3 is type D quasi-colocated with CSI-IM #3.

Optionally, where the first CSI parameter corresponds to a resource configured for interference measurement for the second sub-configuration, it means that the first CSI parameter corresponds to a resource configured for interference measurement for the second sub-configuration (for example, the resource configured for interference measurement as determined using the methods above). As an example, where the first CSI parameter is a CRI, there is a mapping relationship between the CRI and the resource configured for interference measurement for the second sub-configuration. The mapping relationship may be determined by at least one of the following methods:

### Method 1

The CRI is determined based on an order/position of the resource configured for interference measurement of the sub-configuration in the resource set configured for interference measurement and corresponding to the information for the CSI report configuration. Optionally, the k value corresponding to the CRI indicates the (k+1)th resource associated with the second sub-configuration in the resource set configured for interference measurement and corresponding to the information for the CSI report configuration. For example, if the resource set configured for interference measurement and corresponding to the information for the CSI report configuration is {CSI-RS#1, CSI-RS#3, CSI-RS#4, CSI-RS#7}, the resource configured for interference measurement of the second sub-configuration are CSI-RS#1 and CSI-RS #4, then k=0 corresponds to CSI-RS#1 and k=1 corresponds to CSI-RS#4.

### Method 2

The CRI is determined based on an order (for example, a magnitude order) of the IDs of the resources configured for interference measurement of the second sub-configuration. For example, the order is an ascending order or a descending order. Optionally, the value k corresponding to the CRI indicates the resource with the (k+1)th highest ID (or the (k+1)th lowest) ID among the resources configured for interference measurement of the second sub-configuration. As an example, where the value k corresponding to CRI indicates the resource with the (k+1)th lowest ID among the resources configured for interference measurement of the second sub-configuration, the resource set configured for interference measurement and corresponding to the information for the CSI report configuration is {CSI-RS#3, CSI-RS#1, CSI-RS#4, CSI-RS#7}, and the resources configured for interference measurement of the second sub-configuration are {CSI-RS#3, CSI-RS#1, CSI-RS#4}, then k=0 corresponds to CSI-RS#1; k=1 corresponds to CSI-RS#3; and k=2 corresponds to CSI-RS#4.

The above methods may identify the mapping relationship between the CRI (or k) and the corresponding resource, improving the reliability of the communication system.

In this embodiment, optionally, the bitwidth of the field corresponding to the CRI (for example, the number of bits occupied by k) is based on the number of resources configured for channel measurement for the second sub-configuration, or based on the number of resources configured for interference measurement for the second sub-configuration. For example, the bitwidth of the field corresponding to the CRI is log₂N, where N refers to the number of resources configured for channel measurement for the second sub-configuration. For example, the bitwidth of the field corresponding to the CRI is log₂N, where N refers to the number of resources configured for channel measurement for the second sub-configuration (for example, the number of resources indicated by the first resource parameter). For example, the bitwidth of the field corresponding to the CRI is log₂N, where N refers to the number of resources configured for interference measurement for the second sub-configuration. For example, the bitwidth of the field corresponding to the CRI is log₂N, where N refers to the number of resources configured for interference measurement for the second sub-configuration (for example, the number of resources indicated by the second resource parameter, or the number of resources indicated by the third resource parameter).

In this embodiment, optionally, the CSI resource setting for the information for the CSI report configuration includes (or, only includes) a resource set. Optionally, when the first and/or second conditions are satisfied, the CSI resource setting for the information for the CSI report configuration includes (or, only includes) a resource set. Optionally, the number of resource sets included in/associated with the CSI resource setting for the information for the CSI report configuration is 1. Optionally, the CSI resource setting may be configured for channel measurement and/or for interference measurement. Optionally, the CSI resource setting may correspond to resourcesForChannelMeasurement. Optionally, the CSI resource setting may correspond to csi-IM-ResourcesForInterference. Optionally, the CSI resource setting may correspond to nzp-CSI-RS-ResourcesForInterference. For example, (when a condition described in embodiment 1 is satisfied), the CSI-ResourceConfig corresponding to resourcesForChannelMeasurement in CSI-ReportConfig includes (or only includes) a resource set (for example, NZP-CSI-RS-ResourceSet). (in combination with embodiment 2 as described below) The advantage of such a configuration limitation is that the mapping relationship between a resource set configured for channel measurement and a resource set configured for interference measurement may be defined, improving the reliability of a communication system.

In embodiment 1, optionally, when a first condition and/or a second condition and/or a fourth condition is satisfied (the fourth condition will be described below in conjunction with the specific embodiments), the CSI-related report configuration information parameter does not have a field for a specific parameter. Optionally, a specific parameter includes at least one of a channel resource parameter, a resource group parameter, a QCL information parameter, a CSI-IM resource parameter, and an NZP CSI-RS resource parameter. (in combination with embodiment 3 as described below) Such a configuration limitation is advantageous in that it may avoid conflicts between an indication of the specific parameter and an indication of a parameter included in or corresponding to a sub-configuration, and avoid inconsistencies in the understanding of the resource set configured for channel measurement and/or the resource set configured for interference measurement between a terminal device and a base station, improving the reliability of a communication system.

Optionally, the first sub-configuration and/or the second sub-configuration may include/is associated with/correspond to a port subset indication. Optionally, the port subset indication is configured to indicate a port subset of a CSI-RS (configured for channel measurement). The port subset may be an antenna port subset.

Optionally, the UE determines a second CSI parameter for the second sub-configuration based on a first CSI parameter for the second sub-configuration. Optionally, when a third condition is satisfied, the UE determines a second CSI parameter for the second sub-configuration based on a first CSI parameter for the second sub-configuration. Optionally, when a third condition is satisfied, the UE determines the CSI parameter based on the second sub-configuration. Optionally, the first CSI parameter may be the CRI. Optionally, the first CSI parameter may be at least one of the RI, the PMI, the CQI, and the LI. Optionally, the second CSI parameter may be a CSI parameter other than the first CSI parameter. Optionally, the second CSI parameter may be a CSI parameter other than the CRI. Optionally, the second CSI parameter may be at least one of the RI, the PMI, the CQI, and the LI. Optionally, the third condition includes at least one of the following:
The first condition is not satisfied. In other words, when the first condition is not satisfied, the UE determines a second CSI parameter for the second sub-configuration based on a first CSI parameter for the second sub-configuration. The first condition is described above.
The second sub-configuration is configured with a type 1 parameter. Optionally, the type 1 parameter is configured to indicate a type 2 adaptation.
(One or all of) one or more first sub-configurations are configured with a type 1 parameter. Optionally, the type 1 parameter is configured to indicate a type 1 adaptation.
One or more first sub-configurations have different CSI-RS ports (optionally, CSI-RS port subsets). Optionally, the CSI-RS port refers to a CSI-RS port (optionally, a port subset) indicated by the second sub-configuration. Optionally, the CSI-RS port may be a CSI-RS port configured for channel measurement. The CSI port may be a CSI-RS antenna port. Optionally, the CSI-RS port corresponds to a resource (for example, a reference signal resource) configured for channel measurement.
The second sub-configuration includes/corresponds to/is associated with/indicates a port subset. Optionally, the port subset refers to a CSI-RS port subset (optionally, a CSI-RS antenna port subset). Optionally, the port subset refers to a port subset of a CSI-RS (configured for channel measurement) of the second sub-configuration (or, a CSI-RS antenna port subset).
(One or all of) one or more first sub-configurations include/correspond to/are associated with/indicate a port subset. Optionally, (one or all of) one or more first sub-configurations include/correspond to/are associated with/indicate different port subsets (for example, CSI-RS antenna port subsets). Optionally, the CSI-RS resources corresponding to the port subset are configured for channel measurement and/or interference measurement.
The number of resources configured for channel measurement for the second sub-configuration is greater than 1. Optionally, the number of reference signal resources configured for channel measurement for the second sub-configuration is greater than 1.
The number of resources configured for channel measurement and corresponding to the CSI configuration information is greater than 1. Optionally, the number of reference signal resources configured for channel measurement for the second sub-configuration is greater than 1. For example, the number of reference signal resources in the resource set (configured for channel measurement) and corresponding to the information for the CSI report configuration (for example, NZP-CSI-RS-ResourceSet) is greater than 1.
The CSI configuration information corresponds to one of an aperiodic CSI report, a semi-persistent CSI report, and an aperiodic CSI report.
The resources configured for channel measurement and/or interference measurement for the second sub-configuration are aperiodic. Optionally, a resource type parameter (for example, resourceType) of the CSI resource setting (CSI-ResourceConfig) (configured for channel measurement and/or interference measurement) for the second sub-configuration and corresponding to the information for the CSI report configuration is set to “aperiodic”.
(One or all of) one or more first sub-configurations include/correspond to/are associated with/indicate that the resources configured for channel measurement and/or for interference measurement are aperiodic. Optionally, a resource type parameter (for example, resourceType) of the CSI resource setting (CSI-ResourceConfig) (configured for channel measurement and/or interference measurement) for the second sub-configuration and corresponding to the information for the CSI report configuration is set to “aperiodic”.

Optionally, the first CSI parameter corresponds to a resource configured for channel measurement for the second sub-configuration and/or a resource configured for interference measurement for the second sub-configuration. The first CSI parameter is described herein by taking CRI as an example. The CRI (or a CRI value) is represented by a parameter k. Optionally, k is a positive integer greater than or equal to 0 (k>=0). For example, different k values represent different resources configured for channel measurement and/or for interference measurement. Optionally, the CRI corresponding to (reported by) the second sub-configuration corresponds to a resource (for example, a reference signal resource) configured for channel measurement for the second sub-configuration. Optionally, when the number of resources configured for channel measurement for the second sub-configuration is greater than 1, the CRI corresponding to the second sub-configuration is reported. Optionally, when the number of resources configured for channel measurement for the second sub-configuration is equal to 1, the value of the CRI corresponding to the second sub-configuration may be (or, may be regarded as) a specific value (for example, 0 or 1).

Optionally, the resources configured for channel measurement for the second sub-configuration include/are one or more, or all, resources in the resource set (for example, NZP-CSI-RS-ResourceSet) that corresponds to/is associated with the information for the CSI report configuration. Optionally, the resource set corresponds to the information for the CSI report configuration. Optionally, a resource set is in a CSI resource setting corresponding to the information for the CSI report configuration. Optionally, the CSI resource setting is configured for channel measurement. For example, the CSI resource setting may be associated with/correspond to a channel measurement resource parameter (for example, resourcesForChannelMeasurement) in the CSI report configuration. For example, the CSI resource setting is a CSI-ResourceConfig parameter. The indication to a resource herein may be either an explicit indication or a direct indication. Optionally, the resource may be a reference signal resource. Optionally, the reference signal resource may be a reference signal. Optionally, the resources include a CSI-RS resource or a CSI-IM resource. Optionally, the CSI-RS may be an NZP CSI-RS.

Optionally, the resources configured for interference measurement for the second sub-configuration include/are one or more, or all, resources in the resource set (for example, NZP-NZP-CSI-RS-ResourceSet or csi-IM-ResourceSet) that corresponds to/is associated with the information for the CSI report configuration. Optionally, the resource set corresponds to the information for the CSI report configuration. Optionally, a resource set is in a CSI resource setting corresponding to the information for the CSI report configuration. Optionally, the CSI resource setting is configured for interference measurement. For example, the CSI resource setting may be associated with/correspond to a CSI-IM resource interference measurement parameter (for example, csi-IM-ResourcesForInterference) in the information for the CSI report configuration. For example, the CSI resource setting may be associated with/correspond to an NZP CSI-RS resource interfernece measurement parameter (for example, nzp-CSI-RS-ResourcesForInterference) in the information for the CSI report configuration. For example, the CSI resource setting is a CSI-ResourceConfig parameter. The indication to a resource herein may be either an explicit indication or a direct indication. Optionally, the resource may be a reference signal resource. Optionally, the reference signal resource may be a reference signal. Optionally, the resources include a CSI-RS resource or a CSI-IM resource. Optionally, the CSI-RS may be an NZP CSI-RS.

The advantage of embodiment 1 is to clarify the method that the resources configured for channel measurement and/or interference measurement for a sub-configuration and the corresponding CSI parameter determination, thus improving the reliability of a communication system.

### Embodiment 2

The UE receives the information for the CSI report configuration (for example, CSI-ReportConfig). Optionally, the information for the CSI report configuration is associated with/corresponds to/includes one or more first sub-configurations. The sub-configuration herein may be referred to as sub-configuration information. Optionally, a first sub-configuration may be sub-configuration information of CSI report.

Optionally, second sub-configuration(s) includes at least one of one or more first sub-configuration(s). Optionally, the second sub-configuration includes at least one of sub-configuration(s) in a subset of the one or more first sub-configuration(s). The first sub-configuration(s) and/or the second sub-configuration(s) is described in embodiment 1.

Optionally, the UE determines/feedbacks the CSI parameter that corresponds to/is associated with the information for the CSI report configuration. Optionally, the UE determines the CSI parameter for the second sub-configuration (included in the information for the CSI report configuration). The specific methods are described in embodiment 1.

Optionally, the UE determines/reports/feeds back an (associated) CSI parameter based on the report configuration information and/or a CSI resource setting and/or a second sub-configuration. Optionally, a CSI parameter may be at least one of a CSI-RS resource indicator (CRI), a rank indicator (RI), a precoding matrix indicator (PMI), a channel quality indicator (CQI), a layer indicator (LI). Optionally, the CSI parameter may be at least one of a CSI-RS resource indicator (CRI), an SS/PBCH block resource indicator (SSBRI), a Layer 1-reference signal receive power (L1-RSRP), a Layer 1-signal interference-to-noise ratio (L1-SINR), and a capability index (CapabilityIndex).

Optionally, if a first condition and/or a second condition are satisfied (and the information for the CSI report configuration includes/is associated with/corresponds to a plurality of first sub-configurations), then the number of resource sets configured by the UE in a CSI resource setting is 1. Optionally, the information for the CSI report configuration (for example, CSI-ResourceConfig) includes/corresponds to/is associated with a CSI resource setting (for example, CSI-ResourceConfigs). Optionally, the CSI resource setting includes/corresponds to/is associated with one or more resource sets. Optionally, the CSI resource setting/resource set may be configured for channel measurement. Optionally, the CSI resource setting/resource set may be configured for interference measurement. Optionally, the CSI resource setting/resource set may perform interference measurement based on the NZP CSI-RS resource. Optionally, the CSI resource setting/resource set may perform interference measurement based on the CSI-IM resource. Optionally, the CSI resource setting/resource set may be aperiodic. Optionally, the CSI resource setting/resource set may be semi-persistent/periodic. Optionally, the CSI resource setting/resource set may correspond to a resource parameter configured for channel measurement (for example, resourcesForChannelMeasurement) in the information for the CSI report configuration. Optionally, the CSI resource setting/resource set may correspond to a CSI-IM resource parameter configured for interference measurement (for example, csi-IM-ResourcesForInterference) in the information for the CSI report configuration. Optionally, the CSI resource setting/resource set may be correspond to an NZP CSI-RS resource parameter configured for interference measurement (for example, nzp-CSI-RS-ResourcesForInterference) in the information for the CSI report configuration. Optionally, the first condition includes at least one of the following:
The second sub-configuration is configured with a type 2 parameter. Optionally, the type 2 parameter is configured to indicate a type 2 adaptation.
(One or all of) one or more first sub-configurations are configured with a type 2 parameter. Optionally, the type 2 parameter is configured to indicate a type 2 adaptation.
One or more first sub-configurations have a same CSI-RS port. Optionally, the CSI-RS port refers to a CSI-RS port that corresponds to a port number parameter (for example, nrofPorts). Optionally, the CSI-RS port may be a CSI-RS port configured for channel measurement. The CSI port may be a CSI-RS antenna port. Optionally, the CSI-RS port corresponds to a resource (for example, a reference signal resource) configured for channel measurement.
The second sub-configuration includes/corresponds to/is associated with/indicates one or more resources. Optionally, the one or more resources are configured for channel measurement and/or interference measurement. Optionally, the one or more resources are reference signal resources configured for channel measurement. Optionally, the one or more resources are reference signal resources configured for interference measurement. Optionally, the second sub-configuration includes/corresponds to/is associated with one or more lists, which respectively indicate one or more resources. Optionally, the one or more reference signal resources include reference signal resources in a resource set (for example, NZP-CSI-RS-ResourceSet). Optionally, the one or more resources include resources in a resource set (for example, csi-IM-ResourceSet). Optionally, the resource set corresponds to the information for the CSI report configuration. For example, a resource set is in a CSI resource setting corresponding to the information for the CSI report configuration. For example, the CSI resource setting is CSI-ResourceConfig.
(One or all of) one or more first sub-configurations include/correspond to/are associated with/indicate one or more resources. Optionally, the one or more resources are configured for channel measurement and/or interference measurement. Optionally, the second sub-configuration includes/corresponds to/is associated with one or more lists, which indicate one or more resources. Optionally, the one or more resources include reference signal resources in a resource set (for example, NZP-CSI-RS-ResourceSet). Optionally, the one or more resources include resources in a resource set (for example, csi-IM-ResourceSet). Optionally, the resource set corresponds to the information for the CSI report configuration. For example, a resource set is in a CSI resource setting corresponding to the information for the CSI report configuration. For example, the CSI resource setting is CSI-ResourceConfig.
The number of resources configured for channel measurement for the second sub-configuration is greater than 1. Optionally, the number of reference signal resources configured for channel measurement for the second sub-configuration is greater than 1.
The CSI configuration information corresponds to one of an aperiodic CSI report, a semi-persistent CSI report, and an aperiodic CSI report.
The resources configured for channel measurement and/or interference measurement for the second sub-configuration are aperiodic. Optionally, a resource type parameter (for example, resourceType) of the CSI resource setting (CSI-ResourceConfig) (configured for channel measurement and/or interference measurement) for the second sub-configuration and corresponding to the information for the CSI report configuration is set to “aperiodic”.
(One or all of) one or more first sub-configurations include/correspond to/are associated with/indicate that the resources configured for channel measurement and/or for interference measurement are aperiodic. Optionally, a resource type parameter (for example, resourceType) of the CSI resource setting (CSI-ResourceConfig) (configured for channel measurement and/or interference measurement) for the second sub-configuration and corresponding to the information for the CSI report configuration is set to “aperiodic”.

Optionally, the second condition includes at least one of the following:
The information for the CSI report configuration corresponds to a plurality of (aperiodic) resource sets. Optionally, the resource set may be configured for channel measurement and/or for interference measurement. Optionally, the resource setting configured for channel measurement and corresponding to (or associated with) the information for the CSI report configuration includes a plurality of (aperiodic) resource sets. For example, the CSI-ResourceConfig configured by the resourcesForChannelMeasurement parameter for CSI-ReportConfig includes a plurality of resource sets (for example, NZP-CSI-RS-ResourceSet).
The information for the CSI report configuration corresponds to an aperiodic resource set. Optionally, the resource set may be configured for channel measurement and/or for interference measurement. Optionally, the resource setting configured for channel measurement and corresponding to (or associated with) the information for the CSI report configuration includes an aperiodic resource set. For example, the CSI-ResourceConfig configured by the resourcesForChannelMeasurement parameter for CSI-ReportConfig includes a resource set (for example, NZP-CSI-RS-ResourceSet). For example, the resource type of the resource setting is aperiodic.
A UE is configured with a CSI aperiodic triggering state list parameter (CSI-AperiodicTriggerStateList).

Optionally, if the UE does not satisfy the first condition and does not satisfy the second condition (or, if the UE does not satisfy the first condition but satisfies the second condition), the number of resource sets configured by the UE in a CSI resource setting is lower than or equal to X1. Optionally, if the CSI resource setting corresponds to the NZP CSI-RS resource (or, resource set), X1 is maxNrofNZP-CSI-RS-Re sourceSetsPerConfig. Optionally, if the CSI resource setting corresponds to the CSI-IM resource (or, resource set), X1 is maxNrofNZP-CSI-RS-ResourceSetsPerConfig. Optionally, X1 is based on UE capabilities. For example, X1 is based on a capability parameter reported by the UE. Optionally, X1 is predefined. For example, X1 is one of 4, 8, 16, 32, and 64. Optionally, X1 is configured by a radio resource control (RRC) signaling.

The advantage of embodiment 2 is that a configuration limit is set for the number of resource sets included in the information for the CSI report configuration, so as to avoid the situation where the information for the CSI report configuration corresponds to a plurality of resource sets when a CSI report corresponds to a plurality of sub-configurations, which can avoid defining additional overhead signaling for indication, improving the reliability of a communication system.

### Embodiment 3

The UE receives the information for the CSI report configuration (for example, CSI-ReportConfig). Optionally, the information for the CSI report configuration is associated with/corresponds to/includes one or more first sub-configurations. The sub-configuration herein may be referred to as sub-configuration information. Optionally, a first sub-configuration may be sub-configuration information of CSI report.

Optionally, a second sub-configuration includes at least one of one or more first sub-configurations. Optionally, the second sub-configuration includes at least one of sub-configurations in a subset of the one or more first sub-configurations. The first sub-configuration and/or the second sub-configuration is described in embodiment 1.

Optionally, the UE determines/feeds back the CSI parameter that corresponds to/is associated with the information for the CSI report configuration. Optionally, the UE determines the CSI parameter for the second sub-configuration (included in the information for the CSI report configuration). The specific methods are described in embodiment 1.

Optionally, the UE determines/reports/feeds back an (associated) CSI parameter based on the report configuration information and/or a CSI resource setting and/or a second sub-configuration. Optionally, a CSI parameter may be at least one of a CSI-RS resource indicator (CRI), a rank indicator (RI), a precoding matrix indicator (PMI), a channel quality indicator (CQI), a layer indicator (LI). Optionally, the CSI parameter may be at least one of a CSI-RS resource indicator (CRI), an SS/PBCH block resource indicator (SSBRI), a Layer 1-reference signal receive power (L1-RSRP), a Layer 1-signal interference-to-noise ratio (L1-SINR), and a capability index (CapabilityIndex).

Optionally, a UE receives/is provided with a CSI aperiodic triggering state list parameter (for example, CSI-AperiodicTriggerStateList). Optionally, one triggering state in the CSI aperiodic triggering state list parameter corresponds to/is associated with the information for the CSI report configuration. Optionally, one CSI-related report configuration information parameter for one triggering state in the CSI aperiodic triggering state list parameter (for example, CSI-AssociatedReportConfigInfo) corresponds to/is associated with the information for the CSI report configuration. For example, the CSI report ID (for example, reportConfigId) in the CSI-related report configuration information parameter included in/corresponding to the triggering state is configured to identify the information for the CSI report configuration (for example, the ID of the information for the CSI report configuration is the same as the ID included in the triggering state).

When the UE satisfies a first condition and/or a second and/or a fourth condition (and the information for the CSI report configuration includes/is associated with/corresponds to a plurality of first sub-configurations), the CSI-related report configuration information parameter (corresponding to the information for the CSI report configuration) does not include the channel resource parameter (resourcesForChannel). Optionally, the first resource parameter indicates/selects one set of a plurality of resources sets (configured for channel measurement) and/or a beam of each reference signal resource in the selected/indicated resource set. Here, not including the channel resource parameter may means that the CSI-related report configuration parameter does not have a field configured for the channel resource parameter. Here, for example, the beam is at least one of a QCL parameter, a transmission configuration indication (TCI) state, and a spatial filter. Here, the fourth condition refers to at least one of the following:
(One or more) first sub-configurations include/are associated with/correspond to at least one of a first resource set indication parameter, a second resource set indication parameter, and a third resource set indication parameter.
A second sub-configuration (or each sub-configuration corresponding to the second sub-configuration) includes/is associated with/corresponds to at least one of a first resource set indication parameter, a second resource set indication parameter, and a third resource set indication parameter.

When the UE satisfies a first condition and/or a second and/or a fourth condition (and the information for the CSI report configuration includes/is associated with/corresponds to a plurality of first sub-configurations), the CSI-related report configuration information parameter (corresponding to the information for the CSI report configuration) does not include a resource group parameter (resourceSet). Optionally, the resource group parameter is configured to indicate/select one of a plurality of resource sets (configured for channel measurement). Optionally, the resource group parameter is in the resource parameter (resourcesForChannel). Here, not including the resource group parameter may means that the CSI-related report configuration parameter does not have a field configured for the resource group parameter.

When the UE satisfies a first condition and/or a second and/or a fourth condition (and the information for the CSI report configuration includes/is associated with/corresponds to a plurality of first sub-configurations), the CSI-related report configuration information parameter (corresponding to the information for the CSI report configuration) does not include a QCL information parameter (qcl-info). Optionally, the QCL information parameter is configured to indicate a beam of each reference signal resource in the resource set (selected/indicated by the resource group parameter). Optionally, the resource group parameter is in the resource parameter (resourcesForChannel). Here, not including the QCL information parameter may means that the CSI-related report configuration parameter does not have a field configured for the QCL information parameter.

When the UE satisfies a first condition and/or a second and/or a fourth condition (and the information for the CSI report configuration includes/is associated with/corresponds to a plurality of first sub-configurations), the CSI-related report configuration information parameter (corresponding to the information for the CSI report configuration) does not include a CSI-IM resource parameter (csi-IM-ResourcesForInterference). Optionally, the CSI-IM resource parameter is configured to indicate/select one of a plurality of resource sets (configured for interference measurement). Optionally, the resource set is a CSI-IM resource set. Here, not including the CSI-IM resource parameter may means that the CSI-related report configuration parameter does not have a field configured for the CSI-IM resource parameter.

When the UE satisfies a first condition and/or a second and/or a fourth condition (and the information for the CSI report configuration includes/is associated with/corresponds to a plurality of first sub-configurations), the CSI-related report configuration information parameter (corresponding to the information for the CSI report configuration) does not include an NZP CSI-RS resource parameter (nzp-CSI-RS-ResourcesForInterference). Optionally, the NZP CSI-RS resource parameter is configured to indicate/select one of a plurality of resource sets (configured for interference measurement). Optionally, the resource set is an NZP CSI-RS resource set. Here, not including the NZP CSI-RS resource parameter may means that the CSI-related report configuration parameter does not have a field configured for the NZP CSI-RS resource parameter.

The embodiment 3 is advantageous in that it limits the configuration for the information for the aperiodic CSI report configuration, which may avoid conflicts between an indication of a parameter included in the CSI-related report configuration information and an indication of a parameter included in or corresponding to a sub-configuration, and avoid inconsistencies in the understanding of the resource set configured for channel measurement and/or the resource set configured for interference measurement between a terminal device and a base station, improving the reliability of a communication system.

### Embodiment 4

The UE receives the information for the CSI report configuration (for example, CSI-ReportConfig). Optionally, the information for the CSI report configuration is associated with/corresponds to/includes one or more first sub-configurations. The sub-configuration herein may be referred to as sub-configuration information. Optionally, a first sub-configuration may be sub-configuration information of CSI report.

Optionally, second sub-configuration(s) includes at least one of one or more first sub-configuration(s). Optionally, the second sub-configuration(s) includes at least one of sub-configuration(s) in a subset of the one or more first sub-configuration(s). The first sub-configuration and/or the second sub-configuration is described in embodiment 1.

Optionally, the UE determines/feedbacks the CSI parameter that corresponds to/is associated with the information for the CSI report configuration. Optionally, the UE determines the CSI parameter for the second sub-configuration (included in the information for the CSI report configuration). The specific methods are described in embodiment 1.

Optionally, when the information for the CSI report configuration (for example, CSI-ReportConfig) includes a report quantity parameter (for example, reportQuantity) (included in a CSI report), and the parameter is not set to “none” (for example, the CSI report is to feedback report quantity), CPU(s) (CSI processing unit) occupies a specific time resource (for example, one or more symbols or one or more slots). Optionally, the specific time resource refers to/includes at least one of the following:
When the CSI report (for example, the CSI report corresponding to the information for the CSI report configuration) is periodic or semi-persistent (excluding an initial semi-persistent CSI report on PUSCH after the PDCCH triggering the report), the time resources occupied by the CPU(s) of the CSI report is:
from the first symbol/first slot/earliest symbol/earliest slot of the earliest one of each the following resources: CSI-RS resource, CSI-IM resource, SSB resource; and
until the last symbol/slot of the (configured) PUSCH/PUCCH carrying the CSI report.

Here, optionally, the CSI-RS and/or CSI-IM and/or SSB resource are configured for channel measurement and/or interference measurement. Optionally, the latest CSI-RS and/or CSI-IM and/or SSB occasion corresponding to the CSI-RS and/or CSI-IM and/or SSB resource is no later than the corresponding CSI reference resource. Optionally, when a ninth condition is satisfied, (to determine the time resource of the CPU(s) that is occupied by the CSI report), the CSI-RS and/or CSI-IM and/or SSB occasion is determined based on the CSI-RS and/or CSI-IM and/or SSB occasion within the DRX active period and/or the cell DTX active period. Optionally, when a ninth condition is satisfied, (to determine the time resource of the CPU(s) occupied by the CSI report), the latest CSI-RS and/or CSI-IM and/or SSB occasion corresponding to the CSI-RS and/or CSI-IM and/or SSB resource no later than the corresponding CSI reference resource is determined based on the CSI-RS and/or CSI-IM and/or SSB occasion within the DRX active time and/or the active period(s) of cell DTX. For example, when the ninth condition is satisfied (for example, when the ninth condition at least includes that the DRX is configured), the CSI-RS and/or CSI-IM and/or CSI-IM and/or SSB occasion corresponding to the CSI-RS and/or CSI-IM and/or SSB resource refers to/includes/is based on the latest CSI-RS and/or CSI-IM and/or SSB occasion corresponding to the CSI-RS and/or CSI-IM and/or SSB resource, no later than the corresponding CSI reference resource, and within the DRX active time. For example, when the ninth condition is satisfied (for example, when the ninth condition includes at least that the cell DTX is activated), the CSI-RS and/or CSI-IM and/or SSB occasion corresponding to the CSI-RS and/or CSI-IM and/or SSB resource refers to/includes/is based on the latest CSI-RS and/or CSI-IM and/or SSB occasion corresponding to the CSI-RS and/or CSI-IM and/or SSB resource, no later than the corresponding CSI reference resource, and within the active period(s) of cell DTX. For example, when the ninth condition is satisfied (for example, when the ninth condition includes at least that DRX is configured and the cell DTX is activated), the CSI-RS and/or CSI-IM and/or SSB occasion corresponding to the CSI-RS and/or CSI-IM and/or SSB resource refers to/includes/is based on the latest CSI-RS and/or CSI-IM and/or or SSB resource corresponding to the CSI-RS and/or CSI-IM and/or SSB resource, no later than the corresponding CSI reference resource, and within the DRX active time and the active period(s) of cell DTX. Here, the ninth condition includes at least one of the following:
The CSI report is semi-persistent CSI report or periodic CSI report;
The CSI report is carried in a PUSCH/PUCCH;
A report quantity parameter (for example, reportQuantity) configured for/corresponding to the CSI report is not set to “none”. For example, the CSI report is configured to determine/report a CSI parameter;
A report quantity parameter (for example, reportQuantity) configured for/corresponding to the CSI report includes at least “RI”. For example, a report quantity parameter (for example, reportQuantity) configured for/corresponding to the CSI report is set to “cri-RI-PMI-CQI”. For example, a report quantity parameter (for example, reportQuantity) configured for/corresponding to the CSI report is set to “cri-RI-CQI”.
The cell DTX is activated, and/or, the cell DTX is configured. For example, the cell DTX is configured/activated on the cell where the CSI report is located/configured.
DRX is configured on the cell where the CSI report is located/configured. Here, the DRX can be either UE DRX or C-DRX.
The UE is configured with DRX. Here, the DRX can be either UE DRX or C-DRX (connected mode DRX).

Optionally, the CSI-RS and/or CSI-IM resource (configured for channel measurement and/or interference measurement) may be the CSI-RS and/or CSI-IM resource corresponding to a plurality of first sub-configurations or second sub-configuration(s) (for example, all sub-configurations of the plurality of first sub-configurations or second sub-configurations) corresponding to the CSI report. For example, the CSI-RS and/or CSI-IM resource (configured for channel measurement and/or interference measurement) may be determined by the CSI-RS and/or CSI-IM resource corresponding to (all) sub-configurations that correspond to the reported CSI (or the CSI report). For example, the CSI-RS and/or CSI-IM resource (configured for channel measurement and/or interference measurement) may be determined based on the CSI-RS and/or CSI-IM resource corresponding to the second sub-configuration (for example, N sub-configurations), or may be determined by the CSI-RS and/or CSI-IM resource corresponding to a plurality of first sub-configurations (for example, L sub-configurations). Optionally, the methods for determining the CSI-RS and/or CSI-IM resources (configured for channel measurement and/or interference measurement) are described in embodiment 1.

Optionally, when condition X is satisfied, the CSI-RS and/or CSI-IM resource (configured for channel measurement and/or interference measurement) is determined based on the CSI-RS and/or CSI-IM resource corresponding to a plurality of first sub-configurations (for example, L sub-configurations). Optionally, the condition X includes at least one of the following:
The CSI report is periodic.
The CSI report is semi-persistent. For example, the semi-persistent CSI report is carried by a PUSCH or a PUCCH
The CSI report is aperiodic. For example, the aperiodic report is carried by a PUSCH.
The CSI-RS and/or CSI-IM resource (configured for channel measurement and/or interference measurement) is periodic and/or semi-persistent.

Optionally, when a condition Y is satisfied, then the CSI-RS and/or CSI-IM resource (configured for channel measurement and/or interference measurement) is determined based on the CSI-RS and/or CSI-IM resource corresponding to the second sub-configuration(s) (for example, N sub-configuration(s)). Optionally, a condition Y includes at least one of the following:
The CSI report is semi-persistent. For example, the semi-persistent CSI report is carried by a PUSCH or a PUCCH
The CSI report is aperiodic. For example, the aperiodic report is carried by a PUSCH.
The CSI-RS and/or CSI-IM resource (configured for channel measurement and/or interference measurement) is aperiodic.

Optionally, for a sub-configuration, the CSI-RS and/or CSI-IM resource is determined based on at least one of a first reference resource parameter, a second reference resource parameter, and a third reference resource parameter indicated by the second sub-configuration. For example, for a sub-configuration, the CSI-RS resource configured for channel measurement is indicated based on the first reference resource parameter. For example, for a sub-configuration, the CSI-IM resource configured for interference measurement is indicated based on the second reference resource parameter, or, determined based on a resource indicated by a first reference resource parameter, and a resource set configured for interference measurement and corresponding to the CSI report. For example, for a sub-configuration, the CSI-RS is indicated based on a third reference resource parameter, or determined based on a resource indicated by a first reference resource parameter, and a resource set configured for interference measurement and corresponding to the CSI report.

The following describes the time resource of the CPU(s) occupied by the CSI report configured for CSI prediction. Optionally, the codebook type corresponding to CSI report configured for CSI prediction may be configured as a Type 2 Doppler codebook. For example, a codebook type parameter (for example, codebookType) for CSI report configured for CSI prediction may be set to “typeII-Doppler-r18”, or “typeII-Doppler-PortSelection-r18”. Optionally, the CSI report configured for CSI prediction may be a CSI report configured for beam prediction. Optionally, the CSI report configured for CSI prediction may be a CSI report configured for time domain and/or spatial beam prediction.

The UE receives information for the CSI report configuration (for example, CSI-ReportConfig). Optionally, the UE determines/feedbacks/reports the CSI (or CSI parameter) that corresponds to/is associated with the information for the CSI report configuration. When a tenth condition is satisfied, the CSI report occupies the CPU(s) on a time resource (for example, several symbols, or several slots, or several OFDM symbols). (When the tenth condition is satisfied), the time resource is until the last symbol of the PUSCH carrying the report. (When the tenth condition is satisfied), the time resource is based on (or, the time resource is from) at least one of the following:
the first symbol of the Kₚ-th latest consecutive periodic/semi-persistent CSI-RS occasion no later than the CSI reference resource;
the first symbol of the Kₚ-th latest consecutive periodic/semi-persistent CSI-RS occasions no later than CSI reference resource, and when the tenth condition is satisfied (for example, when the tenth condition includes at least one of: DRX is configured and/or the cell DTX activated), the Kₚ-th latest consecutive periodic/semi-persistent CSI-RS occasions no later than CSI reference resource is determined/counted based on the CSI-RS occasions within the DRX active time and/or the active period(s) of cell DTX;
the first symbol of the Kₚ-th latest consecutive periodic/semi-persistent CSI-RS occasion no later than CSI reference resource, and when at least one of the tenth conditions is satisfied (for example, when the tenth condition includes at least one of: DRX is configured and/or the cell DTX activated), the Kₚ-th latest consecutive periodic/semi-persistent CSI-RS occasion no later than CSI reference resource is determined/counted based on the CSI-RS occasions within (the same) DRX active time and/or the (same) active period(s) of cell DTX;
the first symbol of the Kₚ-th latest consecutive periodic/semi-persistent CSI-RS occasion no later than CSI reference resource, and when the tenth condition is satisfied (for example, when the tenth condition includes at least one of: DRX is configured and/or the cell DTX activated), the Kₚ-th latest consecutive periodic/semi-persistent CSI-RS occasion no later than CSI reference resource occurs within (the same) DRX active period and/or the (same) active period(s) of cell DTX;
the first symbol of the Kₚ-th latest consecutive periodic/semi-persistent CSI-RS occasion no later than CSI reference resource, and when the tenth condition is satisfied (for example, when the tenth condition includes at least one of: DRX is configured and/or the cell DTX activated), the CSI-RS occasion associated with/corresponding to the Kₚ-th latest consecutive periodic/semi-persistent CSI-RS occasion no later than CSI reference resource (for determination) (or the consecutive CSI-RS occasions or Kₚ consecutive CSI-RS occasions) occurs within (the same) DRX active period and/or the (same) cell DTX active period;
the first symbol of the Kₚ-th latest consecutive periodic/semi-persistent CSI-RS occasion no later than CSI reference resource and/or within (the same) cell DTX active period;
the first symbol of the Kₚ-th latest consecutive periodic/semi-persistent CSI-RS occasion no later than CSI reference resource and/or within (the same) DRX active time. Here, the DRX may be UE DRX or C-DRX;
the first symbol of the Kₚ-th latest consecutive periodic/semi-persistent CSI-RS occasion no later than CSI reference resource and within (the same) active period(s) of cell DTX and/or within (the same) DRX active time.

The tenth condition includes at least one of the following:
The CSI report is either a semi-persistent CSI report or a periodic report.
The CSI report is carried in a PUSCH/PUCCH;
A report quantity parameter (for example, reportQuantity) configured for/corresponding to the CSI report is not set to “none”. For example, the CSI report is configured to determine/report a CSI parameter.
A report quantity parameter (for example, reportQuantity) configured for/corresponding to the CSI report includes at least “RI”. For example, a report quantity parameter (for example, reportQuantity) configured for/corresponding to the CSI report is set to “cri-RI-PMI-CQI”. For example, a report quantity parameter (for example, reportQuantity) configured for/corresponding to the CSI report is set to “cri-RI-CQI”.
The CSI report is a CSI report configured for CSI prediction, or the codebook type corresponding to the CSI report is set to a Type 2 Doppler codebook. For example, a codebook type parameter (for example, codebookType) configured for/corresponding to the CSI report is set to “typeII-Doppler-r18”, or “typeII-Doppler-PortSelection-r18”;
The cell DTX is activated, and/or, the cell DTX is configured. For example, the cell DTX is configured/activated on the cell where the CSI report is located/configured;
The cell DTX is activated on a cell and the CSI resource setting associated with the CSI report configuration is on the cell;
The cell DTX is activated on a cell and the CSI resource setting associated with the CSI report configuration is on the cell; (refer to Embodiment 7 for the description of the CSI resource setting associated with the CSI report configuration).
DRX is configured on the cell where the CSI report is located/configured. Here, the DRX can be either UE DRX or C-DRX.
The UE is configured with DRX. Here, the DRX can be either UE DRX or C-DRX (connected mode DRX).

The Kₚ-th latest CSI-RS occasion may be understood as that where there are Kₚ CSI-RS occasions, the latest CSI-RS occasion in the time domain may be referred to as the (first) latest CSI-RS occasion, the second latest CSI-RS occasion in the time domain may be referred to as the second latest CSI-RS occasion, and so on. Optionally, the Kₚ CSI-RS occasions may be Kₚ consecutive CSI-RS occasions. Optionally, the CSI-RS occasion may be a periodic/semi-persistent CSI-RS occasion. Optionally, the CSI-RS occasion may be a CSI-RS transmission occasion. Here, the latest CSI-RS occasion may be the latest CSI-RS occasion relative to the CSI reference resource (corresponding to the CSI report), or the latest CSI-RS occasion of the reference CSI report. Optionally, the CSI-RS occasion may be/may be based on at least one of the following:
CSI-RS occasion no later than the corresponding CSI reference resource (for example, a CSI reference resource corresponding to the CSI report);
CSI-RS occasion within the (same) DRX active time;
CSI-RS occasion within the (same) active period(s) of cell DTX;

In the above method, Kₚ may be configured by a base station, or indicated by a UE capability, or predefined. Optionally, the value of Kₚ may be in the range of {1, 2, 4}.

The method for determining the time resource of the CPU(s) occupied by the CSI report (for example, the CSI report configured for CSI prediction) is described above. In the case of cell DTX and/or DRX (for example, UE DRX), the method may use the corresponding condition to limit the CSI measurement occasion (for example, CSI-RS occasion, or CSI occasion, or CSI measurement occasion) configured to determine the time resource occupied by the CSI report to the CSI measurement occasion within the active period(s) of cell DTX and/or the DRX active period, avoiding errors caused by use of the CSI measurement occasion within the cell DTX inactive period and/or DRX inactive period to determine the time resource of the CPU occupied (for example, the UE does not receive the CSI-RS within the cell DTX inactive period and/or the DRX inactive period), thus ensuring the accuracy of the CSI report, which further improves the performance of the communication system. Optionally, the method may use the corresponding condition to limit the CSI measurement occasion (for example, CSI-RS occasion, or CSI occasion) configured to determine the time resource occupied by the CSI report to the CSI measurement occasion within the same cell DTX active period and/or or CSI measurement occasion within the same DRX active period, avoiding channel difference caused by consecutive CSI measurement occasion across multiple cell DTX active periods (time ranges) or across multiple DRX active periods (time ranges) to result in inaccurate measurement CSI report, thereby improving the accuracy of the CSI report and thus improving the performance of the communication system.

In this application, the term “CSI-RS occasion” may be used interchangeably with “CSI occasion”, or “CSI measurement occasion”, or “CSI-IM occasion”, or “SSB occasion”, or “SSB resource occasion”, or, “CSI transmission occasion”, or “CSI-RS transmission occasion”, or “CSI-IM transmission occasion”, or “SSB resource transmit occasion”.

The methods provided in embodiment 4 may determine the time resources occupied by the CPU of a CSI report (for example, a CSI report corresponding to one or more sub-configurations, or a CSI report configured for CSI prediction) (for example, determine a reference signal for computing the time resources occupied by the CPU, and/or the CSI-RS occasion/CSI-IM occasion/SSB occasion for determining the time resource occupied by the CPU), improving the reliability of a communication system.

### Embodiment 5

The UE receives the information for the CSI report configuration (for example, CSI-ReportConfig). Optionally, the information for the CSI report configuration is associated with/corresponds to/includes one or more first sub-configurations. The sub-configuration herein may be referred to as sub-configuration information. Optionally, first sub-configuration(s) may be sub-configuration information of CSI report.

Optionally, a second sub-configuration includes at least one of one or more first sub-configuration(s). Optionally, the second sub-configuration(s) includes at least one of sub-configuration(s) in a subset of the one or more first sub-configuration(s). The first sub-configuration(s) and/or the second sub-configuration(s) is described in embodiment 1.

If one or more aperiodic CSI reports are multiplexed on a PUSCH, and the one or more aperiodic CSI reports include the above CSI report (for example, the CSI report corresponding to a plurality of first sub-configurations), and when a condition Z is satisfied, the UE is not required to update the CSI report. Optionally, the one or more aperiodic CSI reports correspond to a group of overlapping PUCCHs and/or PUSCHs. Herein, the condition Z includes at least one of the following:
The first symbol is earlier than the second symbol. Optionally, the first symbol may be the first symbol of the earliest PUSCH or PUCCH in the group of overlapping PUCCHs and/or PUSCHs (in a slot). Here, the second symbol may be determined based on a first resource (for example, an aperiodic resource) corresponding to the CSI report.
The CSI-RS configured for channel measurement for the CSI report is aperiodic.

Optionally, the first resource may be at least one of a CSI-RS resource configured for channel measurement, a CSI-IM resource configured for interference measurement, and a CSI-RS resource configured for interference measurements. Optionally, the first resource may be an aperiodic resource.

As an example, for aperiodic resource(s), the first resource may be an aperiodic CSI-RS and/or aperiodic CSI-IM resource corresponding to a plurality of first sub-configurations or second sub-configuration(s) (for example, all sub-configurations of the plurality of first sub-configurations or second sub-configuration(s)) corresponding to the CSI report. For example, the first resource is determined by the CSI-RS and/or CSI-IM resource corresponding to (all) sub-configurations that correspond to the reported CSI (or the CSI report). For example, the first resource may be determined based on the CSI-RS and/or CSI-IM resource corresponding to the second sub-configuration (for example, N sub-configurations), or determined by the CSI-RS and/or CSI-IM resource corresponding to a plurality of first sub-configurations (for example, L sub-configurations). Optionally, refer to the embodiment 1 for the methods for determining the first resource.

Optionally, when a condition X is satisfied, the first resource is determined based on the CSI-RS and/or CSI-IM resource corresponding to a plurality of first sub-configurations (for example, L sub-configurations). Optionally, the condition X includes at least one of the following:
The CSI report is periodic.
The CSI report is semi-persistent. For example, the semi-persistent CSI report is carried by a PUSCH or a PUCCH
The CSI report is aperiodic. For example, the aperiodic report is carried by a PUSCH.
The first resource is periodic and/or semi-persistent.

Optionally, when a condition Y is satisfied, the first resource is determined based on the CSI-RS and/or CSI-IM resource corresponding to a second sub-configuration (for example, N sub-configurations). Optionally, a condition Y includes at least one of the following:
The CSI report is semi-persistent. For example, the semi-persistent CSI report is carried by a PUSCH or a PUCCH
The CSI report is aperiodic. For example, the aperiodic report is carried by a PUSCH.
The first resource is aperiodic.

Optionally, for a sub-configuration, the CSI-RS and/or CSI-IM resource is determined based on at least one of a first reference resource parameter, a second reference resource parameter, and a third reference resource parameter indicated by the second sub-configuration. For example, for a sub-configuration, the CSI-RS resource configured for channel measurement is indicated based on the first reference resource parameter. For example, for a sub-configuration, the CSI-IM resource configured for interference measurement is indicated based on the second reference resource parameter, or, determined based on a resource indicated by a first reference resource parameter, and a resource set configured for interference measurement and corresponding to the CSI report. For example, for a sub-configuration, the CSI-RS is indicated based on a third reference resource parameter, or determined based on a resource indicated by a first reference resource parameter, and a resource set configured for interference measurement and corresponding to the CSI report.

The method provided in the embodiment 5 may clarify the resources based on which a CSI report (for example, a CSI report corresponding to a plurality of sub-configurations) determines whether the CSI report needs to be reported, thereby clarifying the behavior of a UE and improving the reliability of a communication system.

### Embodiment 6

The UE receives the information for the CSI report configuration (for example, CSI-ReportConfig). Optionally, the information for the CSI report configuration is associated with/corresponds to/includes a group of sub-configurations (or a group of first sub-configurations, or, one or more first sub-configurations, or L sub-configurations, or N sub-configurations) The following describes how to restrict a time domain of resources (for example, CSI-RS resources) that correspond to the information for the CSI report configuration. The following methods may be combined or consolidated.

### Method 1

When each (or one, or at least one) sub-configuration in the group of sub-configurations (for example, L sub-configurations, or, N sub-configurations) is configured with a list of CSI-RS resources, or, optionally, is configured with a CSI-RS resource list parameter (a parameter configured to indicate a list of CSI-RS resources, or, nzp-CSI-RS-resourceList), and/or, if each (or one, or at least one) sub-configuration in the group of sub-configurations corresponds to a different CSI-RS resource, for the group of CSI-RS resources that include K (for example, K≥1) resources configured for channel measurement and corresponding to the information for the CSI report configuration (for example, the list of CSI-RS resources configured through NZP-CSI-RS-ResourceSet), the time slot offset of the K CSI-RS resources is configured in the X time slot (for example, X∈{1,2}), (and there are no DL/UL switching in between K resources, or two resources (for example, two resources or any two resources in the K CSI-RS resources)), where X=1 indicates that the K resources are configured in a same time slot, and X=2 indicates that the K resources are configured in two adjacent time slots.

### Method 2

When each (or one, or at least one) sub-configuration in group of sub-configurations (for example, L sub-configurations, or, N sub-configurations) is configured with a list of CSI-RS resources, or, optionally, is configured with a CSI-RS resource list parameter (a parameter configured to indicate a list of CSI-RS resources, or, nzp-CSI-RS-resourceList), and/or, if resources respectively corresponding to each (or one, or at least one) sub-configuration in the group of sub-configurations have no overlapping, for the list of CSI-RS resources that include K (for example, K≥1) resources configured for channel measurement and corresponding to the information for the CSI report configuration (for example, the list of CSI-RS resources configured through NZP-CSI-RS-ResourceSet), the time slot offset of the K CSI-RS resources are configured in the X time slot (for example, X∈{1,2}), (and there are no DL/UL switching in between K resources, or two resources (for example, two resources or any two resources in the K CSI-RS resources)), where X=1 indicates that the K resources are configured in a same time slot, and X=2 indicates that the K resources are configured in two adjacent time slots.

### Method 3

When each (or one, or at least one) sub-configuration in the group of sub-configurations (for example, L sub-configurations, or, N sub-configurations) is configured with a list of CSI-RS resources, or, optionally, is configured with a CSI-RS resource list parameter (a parameter configured to indicate a list of CSI-RS resources, or, nzp-CSI-RS-resourceList), and/or, if each (or one, or at least one) sub-configuration in the group of sub-configurations corresponds to a different CSI-RS resource, for any two CSI-RS resources corresponding to different sub-configurations respectively, the time slot offset of the two CSI-RS resources is configured in the X time slot (for example, X∈{1,2}), (and there are no DL/UL switching in between the two resources), where X=1 indicates that the two resources are configured in a same time slot, and X=2 indicates that the two resources are configured in two adjacent time slots.

### Method 4

When each (or one, or at least one) sub-configuration in the group of sub-configurations (for example, L sub-configurations, or, N sub-configurations) is configured with a list of CSI-RS resources, or, optionally, is configured with a CSI-RS resource list parameter (a parameter configured to indicate a list of CSI-RS resources, or, nzp-CSI-RS-resourceList), and/or, if resources respectively corresponding to each (or one, or at least one) sub-configuration in the group of sub-configurations have no overlapping, for any two CSI-RS resources corresponding to different sub-configurations respectively, the time slot offset of the two CSI-RS resources are configured in the X time slot (for example, X∈{1,2}), (and there are no DL/UL switching in between the two resources), where X=1 indicates that the two resources are configured in a same time slot, and X=2 indicates that the two resources are configured in two adjacent time slots.

### Method 5

When each (or one, or at least one) sub-configuration in the group of sub-configurations (for example, L sub-configurations, or, N sub-configurations) corresponds to a different CSI-RS resource (or the respective resources have no overlapping), the time slot offset of the two CSI-RS resources is configured in the X time slot (for example, X∈{1,2}), (and there are no DL/UL switching in between the two resources), where X=1 indicates that the two resources are configured in a same time slot, and X=2 indicates that the two resources are configured in two adjacent time slots.

### Method 6

When each (or one, or at least one) sub-configuration in group of sub-configurations (for example, L sub-configurations, or, N sub-configurations) corresponds to a different CSI-RS resource (or respective resources have no overlapping), for the list of CSI-RS resources that include K (for example, K≥1) resources configured for channel measurement and corresponding to the information for the CSI report configuration (for example, the list of CSI-RS resources configured through NZP-CSI-RS-ResourceSet), the time slot offset of the K CSI-RS resources are configured in the X time slot (for example, X∈{1,2}), (and there are no DL/UL switching in between K resources, or two resources (for example, two resources or any two resources in the K CSI-RS resources)), where X=1 indicates that the K resources are configured in a same time slot, and X=2 indicates that the K resources are configured in two adjacent time slots.

### Method 7

When each (or one, or at least one) sub-configuration in the group of sub-configurations (for example, L sub-configurations, or, N sub-configurations) is configured with a list of CSI-RS resources, or, optionally, is configured with a CSI-RS resource list parameter (a parameter configured to indicate a list of CSI-RS resources, or, nzp-CSI-RS-resourceList), and/or, if the CSI-RS resources respectively correspond to each (or one, or at least one) sub-configuration in the group of sub-configurations are different (or are not completely the same), for the list of CSI-RS resources that include K (for example, K≥1) resources configured for channel measurement and corresponding to the information for the CSI report configuration (for example, the list of CSI-RS resources configured through NZP-CSI-RS-ResourceSet), the time slot offset of the K CSI-RS resources is configured in the X time slot (for example, X∈{1,2}), (and there are no DL/UL switching in between K resources, or two resources (for example, two resources or any two resources in the K CSI-RS resources)), where X=1 indicates that the K resources are configured in a same time slot, and X=2 indicates that the K resources are configured in two adjacent time slots.

### Method 8

When each (or one, or at least one) sub-configuration in the group of sub-configurations (for example, L sub-configurations, or, N sub-configurations) is configured with a list of CSI-RS resources, or, optionally, is configured with a CSI-RS resource list parameter (a parameter configured to indicate a list of CSI-RS resources, or, nzp-CSI-RS-resourceList), and/or, if the CSI-RS resources respectively correspond to each (or one, or at least one) sub-configuration in the group of sub-configurations are different (or are not completely the same), for any two CSI-RS resources corresponding to different sub-configurations respectively, the time slot offset of the two CSI-RS resources is configured in the X time slot (for example, X∈{1,2}), (and there are no DL/UL switching in between the two resources), where X=1 indicates that the two resources are configured in a same time slot, and X=2 indicates that the two resources are configured in two adjacent time slots.

In this embodiment, the term “CSI-RS” may be used interchangeably with the term “NZP CSI-RS”.

The method provided in the embodiment 6 may identify the time domain limit of a CSI report, to avoid large separation of CSI-RS resources corresponding to different sub-configurations in the time domain (resulting in no comparability of CSI between different sub-configurations), so that the CSIs corresponding to different sub-configurations may be compared more accurately, improving the accuracy of CSI report, and further improving the performance of a communication system.

### Example 7

A UE may be configured with a CSI report configuration (e.g., CSI-ReportConfig), wherein the CSI report configuration may be associated with a CSI resource setting. Optionally, the CSI resource setting may include a CSI resource setting for channel measurement and/or a CSI resource setting for interference measurement. Optionally, the CSI resource setting may correspond to/include one or more resource set(s). Optionally, the CSI resource setting may correspond to/include at least one of CSI-RS resource, CSI-IM resource and SSB resource. Optionally, a resource set may include several resource(s). Optionally, the resource set may include/correspond to at least one of CSI-RS resource, CSI-IM resource and SSB resource. For example, the UE can determine and/or report the CSI corresponding to/associated with the CSI report configuration based on the measurement of resource(s) in the CSI resource setting associated with the CSI report configuration.

In some cases, the UE may be configured with several serving cell(s). Optionally, one/each of the several serving cells may be configured and/or activated with cell DTX. For example, among several serving cells with which the UE is configured, the cell DTX of some cells is activated, while the cell DTX of other cells is not activated. UE behaviours related to CSI measurement/CSI report may be affected by the cell DTX. The resource measurement and/or CSI report behaviours associated with the CSI report configuration and which serving cell(s) with cell DTX activated needs to be clarified. Note that the cell where the CSI report configuration is located and the cell where the CSI resource setting associated with the CSI report configuration is located can be the same or different. For example, the CSI report configuration may include a higher-layer parameter (e.g., carrier) to indicate the cell where the associated CSI resource setting is located. For example, the UE may determine the cell where corresponding measurement resource is located based on the higher-layer parameter (e.g., carrier) that may be included in the CSI report configuration. For example, the UE can determine which cell to measure on based on the higher-layer parameter (e.g., carrier) that may be included in the CSI report configuration. For example, when the CSI report configuration does not include the higher-layer parameter (for example, carrier), the cell where corresponding/associated CSI resource setting is located is the same as the cell where the CSI report configuration is located. For example, when the CSI report configuration does not include the higher-layer parameter (e.g., carrier), associated CSI resource setting is on the cell where the CSI report configuration is located. Since whether the cell DTX is activated is determined independently on each cell, restriction is provided in the following method that corresponding resource measurement and/or CSI reporting behaviours corresponding to the CSI report configuration are affected by the cell DTX when the cell DTX is activated a cell and the CSI resource setting associated with the CSI report configuration is on the cell. Herein, the term “CSI” and the term “CSI value” can be used interchangeably. Herein, “CSI resource setting associated with CSI report configuration” can be interchanged with terms “CSI resource setting corresponding to CSI report configuration” or “resource(s) associated with CSI report configuration” or “measurement associated with CSI report configuration” or “measurement resource(s) associated with CSI report configuration” or “resource(s) for channel measurement and/or interference measurement associated with CSI report configuration” or “resource(s) for channel measurement associated with CSI report configuration”. Herein, “cell DTX is activated” can be used interchangeably with terms “cell DTX is configured” or “cell DTX is configured and/or activated”.

Optionally, if the higher-layer parameter for channel measurement (e.g., timeRestrictionForChannelMeasurements) in the CSI report configuration (e.g., CSI-ReportConfig) is set to “Configured”, the UE derives channel measurement for computing CSI (reported in uplink slot n) based on (only) an occasion of CSI-RS associated with the CSI resource setting (associated with the CSI report configuration). Optionally, computing CSI may be computing CQI. Optionally, CSI-RS may be NZP CSI-RS. Optionally, the occasion of CSI-RS may be CSI-RS transmission occasion. Here, the CSI-RS occasion refers to/includes/corresponds to at least one of the followings:
Most recent occasion of CSI-RS;
occasion of CSI-RS no later than CSI reference resource;
occasion of CSI-RS within DRX active period;
occasion of CSI-RS within DRX active period if DRX is configured;
occasion of CSI-RS within the cell DTX active period;
occasion of CSI-RS within the cell DTX active period (of a serving cell) if cell DTX is activated and the CSI resource setting associated with the CSI report configuration is on the serving cell.

Here, n may represent a slot number. Optionally, n≥0. Optionally, DRX may be UE DRX or C-DRX.

Optionally, if a higher-layer parameter for interference measurement (e.g., timeRestrictionForInterferenceMeasurements) in the CSI report configuration (e.g., CSI-ReportConfig) is set to “Configured”, the UE derives interference measurement for computing CSI (reported on uplink slot n) based on (only) occasion of CSI-IM and/or CSI-RS associated with the CSI resource setting (associated with the CSI report configuration). Optionally, computing CSI may be computing CQI. Optionally, CSI-RS may be NZP CSI-RS. Optionally, the occasion of CSI-IM may be occasion of CSI-IM transmission. Optionally, the occasion of CSI-RS may be occasion of CSI-RS transmission. Here, occasion of the CSI-IM and/or CSI-RS refer to/includes/corresponds to at least one of the followings:
Most recent occasion of CSI-IM and/or CSI-RS;
occasion of CSI-IM and/or CSI-RS no later than CSI reference resource;
occasion of CSI-IM and/or CSI-RS in DRX active period;
occasion of CSI-IM and/or CSI-RS in DRX active period if DRX is configured;
occasion of CSI-IM and/or CSI-RS in the cell DTX active period;
occasion of CSI-IM and/or CSI-RS in the cell DTX active period (of a serving cell) if cell DTX is activated and the CSI resource setting associated with the CSI report configuration is on the serving cell.

Here, n may represent a slot number. Optionally, n≥0. Optionally, DRX may be UE DRX or C-DRX.

Optionally, for the CSI report configuration with the associated higher-layer parameter associated with report quantity (e.g., reportQuantity) comprising at least “RI”, and (if) the CSI resource setting associated with the CSI report configuration is on the serving cell where cell DTX is activated, the UE reports a CSI report (only) if receiving at least one CSI-IM and/or CSI-RS occasion; otherwise, the UE drops the CSI report. Optionally, the CSI-IM and/or CSI-RS occasion refer to/correspond to/include CSI-IM and/or CSI-RS occasion for (each) periodic or semi-persistent CSI-IM and/or CSI-RS resources for channel measurement and/or interference measurement. Optionally, the CSI-RS occasion refers to/corresponds to/includes CSI-RS occasion for (each) periodic CSI-RS resource or a semi-persistent CSI-RS resource for channel measurement and/or interference measurement. Optionally, the CSI-RS occasion may be a CSI-RS transmission occasion. Optionally, the CSI-IM occasion may be a CSI-IM transmission occasion. Optionally, the CSI-IM and/or CSI-RS occasion refer to/correspond to/include at least one of the followings:
Most recent CSI-IM and/or CSI-RS occasion;
CSI-IM and/or CSI-RS occasion no later than CSI reference resource;
CSI-IM and/or CSI-RS occasion in DRX active period;
CSI-IM and/or CSI-RS occasion in DRX active period if DRX is configured;
CSI-IM and/or CSI-RS occasion in the cell DTX active period;
CSI-IM and/or CSI-RS occasion in the active period of cell DTX (of a serving cell) if cell DTX is activated on the serving cell with the CSI resource setting associated with the CSI report configuration.

Optionally, DRX may be UE DRX or C-DRX.

Optionally, if the CSI resource setting associated with the CSI report configuration is on the serving cell where the cell DTX is activated, the UE does not receive (is not expected to receive) periodic CSI-RS and/or the semi-persistent CSI-RS within cell DTX non-active period (of the serving cell). Optionally, periodic CSI-RS and/or semi-persistent CSI-RS are configured by the CSI report configuration, and the higher-layer parameter (for example, reportQuantity) associated with the CSI report configuration comprising at least “RI”.

Optionally, if the cell DTX is activated for a serving cell and the CSI resource setting associated with the CSI report configuration is on the serving cell, the associated higher-layer parameter related to report quantity (e.g., reportQuantity) comprising at least “RI”, the most recent CSI measurement occasion of semi-persistent CSI-RS resource or periodic CSI-RS resource (associated with the CSI report configuration) occurs in active periods of cell DTX (of the serving cell).

The method provided in Embodiment 7 restricts by conditions that: when the cell DTX of the serving cell where the CSI resource setting associated with/corresponding to the CSI report configuration (or the serving cell where measurement resource is located) is activated, measurement/report corresponding to the CSI report configuration is based on the cell DTX, which clarifies UE behaviours associated with the CSI report configuration and improves the reliability of the communication system.

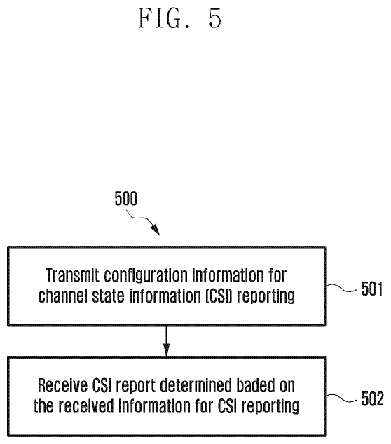

FIG. 5 illustrates a method 500 performed by a base station in accordance with embodiments of the disclosure. The method 510 includes: at 501, transmitting, by the base station, configuration information for CSI report; and at 502, receiving, by the base station, CSI determined and/or reported based on the configuration information for CSI report.

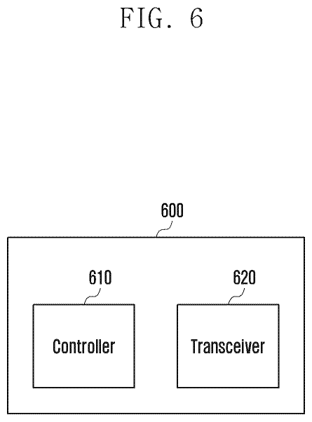

FIG. 6 illustrates a structure 600 of a user equipment in accordance with various embodiments of the disclosure. As shown in FIG. 6, the user equipment 600 includes a controller 610 and a transceiver 620, where the controller 610 is configured to perform various methods performed by a user equipment that are disclosed herein above, and the transceiver 620 is configured to transmit and receive a channel or a signal.

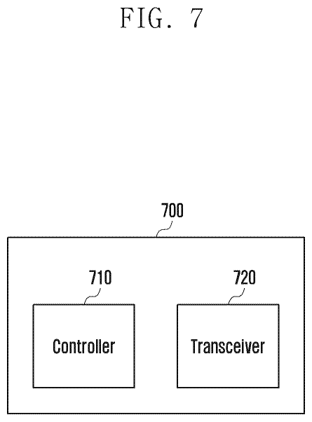

FIG. 7 illustrates a structure 700 of a base station in accordance with various embodiments of the disclosure. As shown in FIG. 7, a network device 700 includes a controller 710 and a transceiver 720, where the controller 710 is configured to perform various method performed by a network device that are disclosed herein above, and the transceiver 720 is configured to transmit and receive a channel or a signal.

As used herein, “reference signal” may be used interchangeably with “reference signal resource”. In addition, as used herein, “CSI parameter” may be used interchangeably with “CSI”. In other words, in the present application, a CSI is described by taking a CSI parameter as an example. In addition, “configuration information for CSI report (for example, csi-ReportConfig)” may be used interchangeably with “CSI report configuration” or “information for a CSI report configuration” or “CSI report setting”.

In this application, resources corresponding to a sub-configuration (for example, CSI-RS resources, CSI-IM resources) may be understood as resources referred by the sub-configuration. The resources referred by a first sub-configuration (or, a plurality of first sub-configurations) may be understood as resources referred by a first sub-configuration (or, a plurality of first sub-configurations). The resources corresponding to a second sub-configuration may be understood as resources referred by a second sub-configuration.

In addition, “at least one/at least a” as described in this disclosure includes any and/or all possible combinations of the items listed, the various embodiments described in this disclosure and the various examples in the embodiments may be altered and combined in any appropriate form, and the “/” described in this disclosure means “or”.

The various illustrative logic boxes, modules, and circuits described in the disclosure may be embodied or executed by a general-purpose processor, a digital signal processor (DSP), an application-specific integrated circuit (ASIC), a field programmable gate array (FPGA) or another programmable logic device, a discrete gate or a transistor logic, a discrete hardware component, or any combination thereof designed to perform the functions described herein. A general-purpose processor may be a microprocessor, but in an alternative scenario, the processor may be any conventional processor, controller, microcontroller, or state machine. The processor may also be implemented as a combination of computing devices, such as a combination of a DSP and a microprocessor, a plurality of microprocessors, one or more microprocessors working with the DSP core, or any other such configurations.

The steps of the method or algorithm described in the disclosure may be embodied directly in hardware, in a software module executed by the processor, or a combination thereof. The software module may reside in an RAM memory, a flash memory, an ROM memory, an EPROM memory, an EEPROM memory, a register, a hard disk, a removable disk, or any other forms of storage media known in the art. An exemplary storage medium is coupled to a processor so that the processor can read and write information from/to the storage medium. Optionally, the storage medium may be integrated into the processor. The processor and storage medium may reside in an ASIC. The ASIC may reside in a user terminal. Optionally, the processor and storage medium may reside in a user terminal as discrete components.

In one or more exemplary designs, the functions may be embodied in hardware, software, firmware, or any combination thereof. If implemented in software, the functions may be stored as one or more instructions or codes on a computer-readable medium or transmitted thereby. The computer-readable medium includes both a computer storage medium and a communication medium, and the latter includes any medium that facilitates the transfer of a computer program from one place to another place. The storage medium may be any available medium that can be accessed by a general-purpose or specialized computer.

By referring to the accompanying drawings, the descriptions set forth herein describe example configurations, methods, and apparatus, and do not represent all examples that are achievable or within the scope of the claims. As used herein, the term “example” means “used as an example, instance, or illustration”, instead of “preferred” or “superior to other examples”. The detailed description includes specific details and is intended to provide an understanding of the technologies described. However, these technologies may be practiced without these specific details. In some cases, well known structures and devices are shown in the block diagrams to avoid obscuring the concept of the examples described.

Although this specification contains a number of specific implementations, these should not be construed as a limitation of any invention or the patentable scope, but rather as a description of the specific characteristics of a particular embodiment of a particular invention. Some of the characteristics described in this specification in the context of various embodiments may also be combined in a single embodiment. In contrast, the various characteristics described in the context of a single embodiment may also be implemented in multiple embodiments individually or in any suitable sub-combinations. In addition, although characteristics may be described above as acting in certain combinations and even being so originally claimed, in some cases, one or more characteristics from the combination for which protection is claimed may be removed from that combination, and the combination for which protection is claimed may be for a sub-combination or a variant of the sub-combination.

It should be understood that the particular sequence or hierarchy of steps in the method of present disclosure is an illustration of the exemplary process. Based on design preferences, it is understood that a particular sequence or hierarchy of steps in a method may be rearranged to achieve the functions and effects disclosed in the disclosure. The attached method claims present the elements of the various steps in the example order and are not meant to be limited to the particular order or level of the presentation, unless otherwise specifically stated. In addition, although it is possible to describe or claim protection elements in the singular form, the plural form is also expected unless the restriction on the singular form is clearly stated. Accordingly, the disclosure is not limited to the examples shown, and any apparatus used to perform the functions described herein is included in all aspects of the disclosure.

The description and drawings are provided as examples only to help readers understand the disclosure. They are not intended and should not be interpreted as limiting the scope of the disclosure in any way. Although certain embodiments and examples have been provided, based on the disclosure herein, it is apparent to those skilled in the art that changes may be made to the illustrated embodiments and examples without departing from the scope of the disclosure.

1. A method performed by a terminal in a wireless communication system, the method comprising:
receiving, from a base station, a channel state information (CSI) report configuration containing a list of sub-configurations; and
transmitting, to the base station, CSI based on the CSI report configuration,
wherein, in case that a report quantity for the CSI report configuration is not set to none and the CSI corresponds to a periodic CSI report, the periodic CSI report occupies CSI processing unit (CPU) from a first symbol of an earliest one of each of resources associated with all configured sub-configurations for the periodic CSI report corresponding to the list of sub-configurations, until a last symbol of a configured physical uplink shared channel (PUSCH) or physical uplink control channel (PUCCH) carrying the periodic CSI report, and
wherein, in case that the report quantity for the CSI report configuration is not set to none and the CSI corresponds to a semi-persistent CSI report, the semi-persistent CSI report occupies CPU from a first symbol of an earliest one of each of resources associated with all configured sub-configurations for the semi-persistent CSI report corresponding to the list of sub-configurations, until a last symbol of a configured PUSCH or PUCCH carrying the semi-persistent CSI report.

2. The method of claim 1,
wherein the sub-configurations for the semi-persistent CSI report includes N sub-configurations, and
wherein a signaling is used to configure the N sub-configurations out of L sub-configurations based on the list of sub-configurations.

3. The method of claim 1,
wherein, in case that if there is one or more aperiodic CSI reports multiplexed on a PUSCH in a group of overlapping PUCCHs and PUSCHs and a third symbol is before a fourth symbol, the UE is not required to update a CSI report for a triggered CSI report associated with multiple sub-configurations,
wherein the third symbol is earliest symbol among the group of overlapping PUCCHs and PUSCHs in a slot, and
wherein, in case that another CSI report configuration includes the multiple sub-configurations for aperiodic CSI report, the fourth symbol is determined based on resources associated with triggered sub-configurations for the triggered CSI report.

4. The method of claim 1,
wherein a bitwidth of a channel state information-reference signal (CSI-RS) resource indicator (CRI) is determined based on a number of CSI-RS resources of a sub-configuration of the list of the sub-configurations, in case that the number of CSI-RS resources of the sub-configuration is greater than 1.

5. A method performed by a base station in a wireless communication system, the method comprising:
transmitting, to a terminal, a channel state information (CSI) report configuration containing a list of sub-configurations; and
receiving, from the terminal, CSI based on the CSI report configuration,
wherein, in case that a report quantity for the CSI report configuration is not set to none and the CSI corresponds to a periodic CSI report, the periodic CSI report occupies CSI processing unit (CPU) from a first symbol of an earliest one of each of resources associated with all configured sub-configurations for the periodic CSI report corresponding to the list of sub-configurations, until a last symbol of a configured physical uplink shared channel (PUSCH) or physical uplink control channel (PUCCH) carrying the periodic CSI report, and
wherein, in case that the report quantity for the CSI report configuration is not set to none and the CSI corresponds to a semi-persistent CSI report, the semi-persistent CSI report occupies CPU from a first symbol of an earliest one of each of resources associated with all configured sub-configurations for the semi-persistent CSI report corresponding to the list of sub-configurations, until a last symbol of a configured PUSCH or PUCCH carrying the semi-persistent CSI report.

6. The method of claim 5,
wherein the sub-configurations for the semi-persistent CSI report includes N sub-configurations, and
wherein a signaling is used to configure the N sub-configurations out of L sub-configurations based on the list of sub-configurations.

7. The method of claim 5,
wherein, in case that if there is one or more aperiodic CSI reports multiplexed on a PUSCH in a group of overlapping PUCCHs and PUSCHs and a third symbol is before a fourth symbol, the UE is not required to update a CSI report for a triggered CSI report associated with multiple sub-configurations,
wherein the third symbol is earliest symbol among the group of overlapping PUCCHs and PUSCHs in a slot, and
wherein, in case that another CSI report configuration includes the multiple sub-configurations for aperiodic CSI report, the fourth symbol is determined based on resources associated with triggered sub-configurations for the triggered CSI report.

8. The method of claim 5,
wherein a bitwidth of a channel state information-reference signal (CSI-RS) resource indicator (CRI) is determined based on a number of CSI-RS resources of a sub-configuration of the list of the sub-configurations, in case that the number of CSI-RS resources of the sub-configuration is greater than 1.

9. A terminal in a wireless communication system, the terminal comprising:
a transceiver; and
at least one processor configured to:
receive, from a base station, a channel state information (CSI) report configuration containing a list of sub-configurations, and transmit, to the base station, CSI based on the CSI report configuration,
wherein, in case that a report quantity for the CSI report configuration is not set to none and the CSI corresponds to a periodic CSI report, the periodic CSI report occupies CSI processing unit (CPU) from a first symbol of an earliest one of each of resources associated with all configured sub-configurations for the periodic CSI report corresponding to the list of sub-configurations, until a last symbol of a configured physical uplink shared channel (PUSCH) or physical uplink control channel (PUCCH) carrying the periodic CSI report, and
wherein, in case that the report quantity for the CSI report configuration is not set to none and the CSI corresponds to a semi-persistent CSI report, the semi-persistent CSI report occupies CPU from a first symbol of an earliest one of each of resources associated with all configured sub-configurations for the semi-persistent CSI report corresponding to the list of sub-configurations, until a last symbol of a configured PUSCH or PUCCH carrying the semi-persistent CSI report.

10. The terminal of claim 9,
wherein the sub-configurations for the semi-persistent CSI report includes N sub-configurations, and
wherein a signaling is used to configure the N sub-configurations out of L sub-configurations based on the list of sub-configurations.

11. The terminal of claim 9,
wherein, in case that if there is one or more aperiodic CSI reports multiplexed on a PUSCH in a group of overlapping PUCCHs and PUSCHs and a third symbol is before a fourth symbol, the UE is not required to update a CSI report for a triggered CSI report associated with multiple sub-configurations,
wherein the third symbol is earliest symbol among the group of overlapping PUCCHs and PUSCHs in a slot, and
wherein, in case that another CSI report configuration includes the multiple sub-configurations for aperiodic CSI report, the fourth symbol is determined based on resources associated with triggered sub-configurations for the triggered CSI report.

12. The terminal of claim 9,
wherein a bitwidth of a channel state information-reference signal (CSI-RS) resource indicator (CRI) is determined based on a number of CSI-RS resources of a sub-configuration of the list of the sub-configurations, in case that the number of CSI-RS resources of the sub-configuration is greater than 1.

13. A base station in a wireless communication system, the base station comprising:
a transceiver; and
at least one processor configured to:
transmit, to a terminal, a channel state information (CSI) report configuration containing a list of sub-configurations, and
receive, from the terminal, CSI based on the CSI report configuration,
wherein, in case that a report quantity for the CSI report configuration is not set to none and the CSI corresponds to a periodic CSI report, the periodic CSI report occupies CSI processing unit (CPU) from a first symbol of an earliest one of each of resources associated with all configured sub-configurations for the periodic CSI report corresponding to the list of sub-configurations, until a last symbol of a configured physical uplink shared channel (PUSCH) or physical uplink control channel (PUCCH) carrying the periodic CSI report, and
wherein, in case that the report quantity for the CSI report configuration is not set to none and the CSI corresponds to a semi-persistent CSI report, the semi-persistent CSI report occupies CPU from a first symbol of an earliest one of each of resources associated with all configured sub-configurations for the semi-persistent CSI report corresponding to the list of sub-configurations, until a last symbol of a configured PUSCH or PUCCH carrying the semi-persistent CSI report.

14. The base station of claim 13,
wherein the sub-configurations for the semi-persistent CSI report includes N sub-configurations, and
wherein a signaling is used to configure the N sub-configurations out of L sub-configurations based on the list of sub-configurations.

15. The method of claim 13,
wherein, in case that if there is one or more aperiodic CSI reports multiplexed on a PUSCH in a group of overlapping PUCCHs and PUSCHs and a third symbol is before a fourth symbol, the UE is not required to update a CSI report for a triggered CSI report associated with multiple sub-configurations,
wherein the third symbol is earliest symbol among the group of overlapping PUCCHs and PUSCHs in a slot,
wherein, in case that another CSI report configuration includes the multiple sub-configurations for aperiodic CSI report, the fourth symbol is determined based on resources associated with triggered sub-configurations for the triggered CSI report, and
wherein a bitwidth of a channel state information-reference signal (CSI-RS) resource indicator (CRI) is determined based on a number of CSI-RS resources of a sub-configuration of the list of the sub-configurations, in case that the number of CSI-RS resources of the sub-configuration is greater than 1.
